(19) United States
(12) Patent Application Publication
(10) Pub. No.: US 2002/0091586 A1
(43) Pub. Date: Jul. 11, 2002

(54) Approval system, apparatus for executing process for approval request and method therefor

(76) Inventors: Masanori Wakai, Kanagawa (JP); Satomi Maeda, Kanagawa (JP); Naoko Yamamoto, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/023,871

(22) Filed: Dec. 21, 2001

(30) Foreign Application Priority Data
Dec. 28, 2000 (JP) 403332/2000
Dec. 20, 2001 (JP) 387856/2001

(51) Int. Cl. G06F 17/60

(52) U.S. Cl. 705/26

(57) ABSTRACT

The invention enables approval decision without a long waiting time of the approval requester even when the approval decider is absent or busy. A client terminal prepares an approval request, and the prepared approval request is stored in an approval request storage portion of a request server. Also an approval service set by the approval decider is stored in a service server. Then the approval service matching the approval request stored in the request server is searched from the approval service server, and the approval decision for the approval request is executed utilizing the searched approval service.

### BACKGROUND OF THE INVENTION

1. Field of the Invention

The present invention relates to an approval system for executing an approval judgment process for an approval request from an approval requesting person, an apparatus for executing a process for an approval request, and a method therefor

2. Related Background Art

FIG. 1 shows an example of the flow of a purchase approval process in the prior art. As shown in FIG. 1, in order to obtain any approval, the approval requester has had to form the request for approval into a document understandable to the approval decider and hand such request to the approval decider for obtaining the approval thereof. Such method has been associated with drawbacks that the approval requester has to actually visit the approval decider and that a long waiting time is required before the approval is actually obtained if the approval decider is busy at the time of such visit.

### SUMMARY OF THE INVENTION

The object of the present invention is to provide an approval system enabling to make an approval request without actually visiting the approval decider.

An information processing apparatus constituting an embodiment of the present invention is provided with approval request preparing means for preparing an approval request, storage means storing an approval service set by an approval service provider, decision means for deciding whether or not to approve the prepared approval request, utilizing the stored approval service, and output means for outputting the decision result of the decision means.

Also an approval system constituting an embodiment of the present invention is provided with a service server for managing plural approval services registered by an approval service provider, and a client terminal including approval request preparing means for preparing an approval request, wherein the client terminal includes acquisition means for searching and acquiring an approval service suitable for the aforementioned approval request among the plural approval services registered in the service server, decision execution means for deciding the approval for the approval request utilizing the acquired approval service, and output means for outputting the result of decision of the decision execution means.

Also a service server constituting an embodiment of the present invention is provided with approval service storage means storing plural approval services which are instructed by the approval service provider for registration, and transmission means for searching an approval service corresponding to the approval request and instructed for search from an external apparatus and transmitting such approval service to the aforementioned external apparatus.

Also an approval system constituting an embodiment of the present invention is provided with a service server for managing plural approval services registered by the approval service provider, a client terminal including approval request preparing means for preparing an approval request, and a request server including approval request storage means for storing the approval request prepared by the client terminal, wherein the request server is provided with approval request storage means for storing the approval request prepared by the client terminal, acquisition means for searching and acquiring an approval service matching the approval request stored in the approval request storage means, among the plural approval services registered in the service server, decision execution means for deciding the approval for the approval request utilizing the acquired approval service, and output means for outputting the result of decision by the decision execution means.

Also an approval system constituting an embodiment of the present invention is provided with a service server for managing plural approval services registered by the approval service provider, and a client terminal including approval request preparing means for preparing an approval request, wherein the client terminal further includes search means for searching an approval service matching the approval request among the plural approval services registered in the service server, transmission means for transmitting the approval request to the service server in case the approval service is searched by the search means, and reception means for receiving the result of decision of the approval for the approval request transmitted from the service server, and the service server includes decision execution means for executing decision of the approval for the approval request transmitted from the client terminal, utilizing the approval service matching the approval request, and transmission means for transmitting the result of decision on approval to the client terminal.

Also an approval system constituting an embodiment of the present invention is provided with a service server for managing plural approval services registered by the approval service provider, a client terminal including approval request preparing means for preparing an approval request, and a request server including approval request storage means for storing the approval request prepared in the client request, wherein the request server includes approval request storage means for storing the approval request prepared in the client terminal, search means for searching an approval service matching the approval request stored in the approval request storage means, among the plural approval services registered in the service server, transmission means for transmitting the approval request to the service server in case the approval service is searched by the search means, and reception means for receiving the result of decision of approval for the approval request from the service server, and the service server includes decision execution means for executing decision of approval for the approval request transmitted from the request server, utilizing the approval service matching the approval request and transmission means for transmitting the result of decision of approval utilizing the approval service matching the approval request.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic view showing the flow of a purchase approval process in the prior art;

FIG. 2 is a schematic view showing a purchase approval process executed in an apparatus or a system in an embodiment 1;

FIG. 3 is a schematic view showing a purchase approval process utilizing a service server in an embodiment 1;

FIG. 4 is a schematic view showing a purchase approval process utilizing a request server in an embodiment 1;

FIG. 5 is a schematic view showing a purchase approval process in an approval service is registered later in an embodiment 4, 5 or 6;

FIG. 6 is a schematic view showing a purchase approval process in a request service is connected later in an embodiment 7 or 8;

FIG. 7 is a block diagram showing the hardware configuration of an information processing apparatus to be employed in the embodiments of the present invention;

FIG. 8 is a flow chart showing the process flow of an entire purchase approval requesting system in an embodiment of the present invention;

FIG. 9 is a flow chart showing the flow of a purchase approval request preparing process in an embodiment of the present invention;

FIG. 10 is a view showing an example of a purchase history in an embodiment of the present invention;

FIG. 11 is a view showing an example of a classification list in an embodiment of the present invention;

FIG. 12 is a view showing an example of a purchase approval request entering image in an embodiment of the present invention;

FIGS. 13 and 14 are views showing examples of a prepared purchase approval request in embodiments of the present invention;

FIG. 15 is a flow chart showing the flow of a purchase approval request process in an embodiment of the present invention;

FIG. 16 is a flow chart showing the flow of a purchase approval decision execution process in an embodiment of the present invention;

FIG. 17 is a view showing the definition of a purchase approval decision execution flag in an embodiment of the present invention;

FIG. 18 is a view showing an example of a purchase approval decision execution prohibiting schedule in an embodiment of the present invention;

FIG. 19 is a view showing an example of budget information in an embodiment of the present invention;

FIG. 20 is a view showing an example of information registered in the service server and also showing a purchase approval flow utilizing the service server, in an embodiment of the present invention;

FIG. 21 is a flow chart showing the process flow of an entire purchase approval service provider system in an embodiment of the present invention;

FIG. 22 is a flow chart showing the process flow of an entire purchase approval service server system in an embodiment of the present invention;

FIG. 23 is a view showing an example of purchase approval service registration information in an embodiment of the present invention;

FIG. 24 is a view showing an example of information registered in the service server and the purchase approval service in an embodiment of the present invention;

FIG. 25 is a flow chart showing the flow of a purchase approval service search process in an embodiment of the present invention;

FIG. 26 is a flow chart showing the flow of a purchase approval decision execution process in an embodiment of the present invention;

FIG. 27 is a view showing an example of Music Flash budget information in an embodiment of the present invention;

FIG. 28 is a view showing an example of music budget information in an embodiment of the present invention;

FIG. 29 is a view showing an example of news budget information in an embodiment of the present invention;

FIG. 30 is a view showing an example of drama budget information in an embodiment of the present invention;

FIG. 31 is a view showing an example of animation budget information in an embodiment of the present invention;

FIG. 32 is a view showing an example of food budget information in an embodiment of the present invention;

FIG. 33 is a view showing an example of luxury item budget information in an embodiment of the present invention;

FIG. 34 is a view showing an example of clothing budget information in an embodiment of the present invention;

FIG. 35 is a view showing an example of amusement budget information in an embodiment of the present invention;

FIG. 36 is a view showing an example of miscellaneous budget information in an embodiment of the present invention;

FIG. 37 is a view showing an example of information registered in a request server and the flow of purchase approval utilizing the request server in an embodiment of the present invention;

FIG. 38 is a flow chart showing the process flow in an entire purchase approval requesting system in an embodiment of the present invention;

FIG. 39 is a flow chart showing the process flow in an entire purchase approval request server system in an embodiment of the present invention;

FIG. 40 is a view showing an example of purchase approval requesting registered information in an embodiment of the present invention;

FIG. 41 is a view showing an example of information registered in the request server and a purchase approval request in an embodiment of the present invention;

FIG. 42 is a flow chart showing the flow of a purchase approval collective decision process in an embodiment of the present invention;

FIG. 43 is a flow chart showing the flow of a purchase approval decision process in an embodiment of the present invention;

FIG. 44 is a schematic view showing a purchase approval process in case an approval service is registered later in relation to a login operation of the user, in an embodiment of the present invention;

FIG. 45 is a flow chart showing the process flow of an entire purchase approval service provider system in an embodiment of the present invention;

FIG. 46 is a view showing an example of purchase decider correspondence information in an embodiment of the present invention;

FIG. 47 is a flow chart showing the process flow of an entire purchase approval service server system in an embodiment of the present invention;

FIG. 48 is a schematic view showing a purchase approval process in case an approval service is registered later in relation to an inserting operation of a purchase approval card including a purchase approval service, in an embodiment of the present invention;

FIG. 49 is a flow chart showing the process flow of an entire purchase approval service provider system in an embodiment of the present invention;

FIG. 50 is a schematic view showing a purchase approval process in case an approval service is registered later in relation to an inserting operation of a purchase approval card including a purchase approval service, in an embodiment of the present invention;

FIG. 51 is a flow chart showing the process flow of an entire purchase approval service provider system in an embodiment of the present invention;

FIG. 52 is a flow chart showing the flow of a purchase approval service preparing process in an embodiment of the present invention;

FIG. 53 is a view showing an example of prepared purchase approval service information in an embodiment of the present invention;

FIG. 54 is a schematic view showing a purchase approval process in case a request server is connected later in relation to a network connecting operation of a PDA, in an embodiment of the present invention;

FIG. 55 is a schematic view showing a purchase approval process in case of a collective registration in the request server in relation to an inserting operation of a purchase approval request card, in an embodiment of the present invention; and

FIG. 56 is a flow chart showing the process flow of an entire purchase approval request server in an embodiment of the present invention.

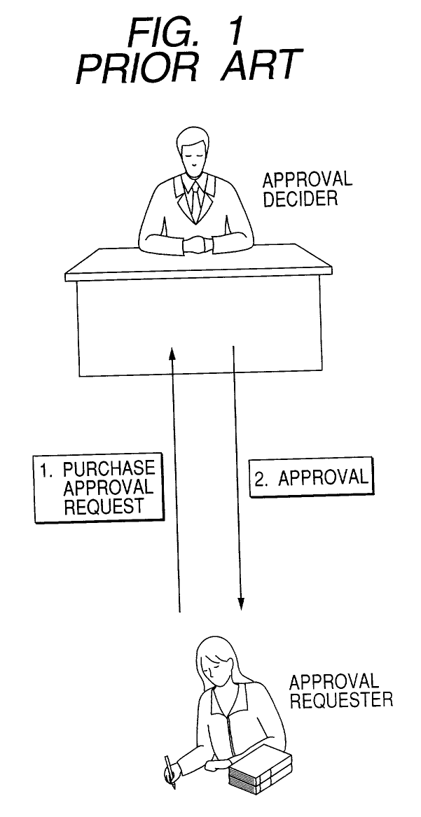

### DETAILED DESCRIPTION OF THE PREFERRED EMBODIMENTS

Now the present invention will be clarified in detail by embodiments thereof, with reference to the accompanying drawings.

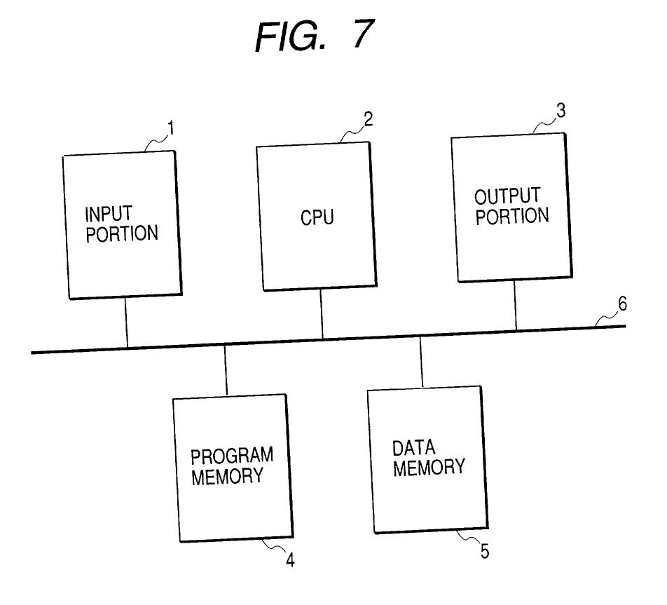

FIG. 7 is a block diagram showing the hardware configuration of an information processing apparatus (client terminal, approval decider terminal, service server, request server etc.) to be employed in the embodiments of the present invention. Referring to FIG. 7, there are provided an input portion 1 for entering information, a CPU 2 for executing various calculations, logic decision etc. for various processings according to computer program thereby controlling various components connected to a bus 6, and an output portion 3 for outputting information.

A program memory 4 stores process sequences to be explained later with reference to the accompanying drawings and other control sequences by the CPU 2, in the form of a program. The program memory 4 can be composed of a ROM, or a RAM in which the programs are loaded from an external memory device.

A data memory 5 stores not only data generated in various processes but also knowledge of a knowledge base to be explained later. The data memory 5 in the present embodiment is composed of a RAM, but the knowledge of the aforementioned knowledge base may be loaded from a non-volatile external memory medium prior to various processes or may be obtained by referring thereto whenever necessary.

A bus 6 transfers address signals for giving instructions to components controlled by the CPU 2, control signals for controlling the components and data to be exchanged between the constituent devices.

(Embodiment)

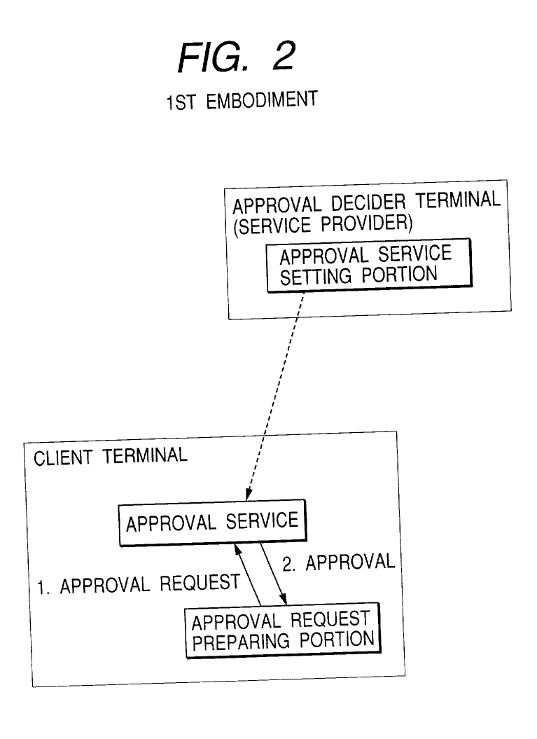

In the present embodiment 1, as shown in FIG. 2, a client apparatus handled by the approval decider receives and stores in advance, in a storage portion, an approval service of which various conditions for approval are set by the approval decider, and executes an approval request decision process utilizing such approval service.

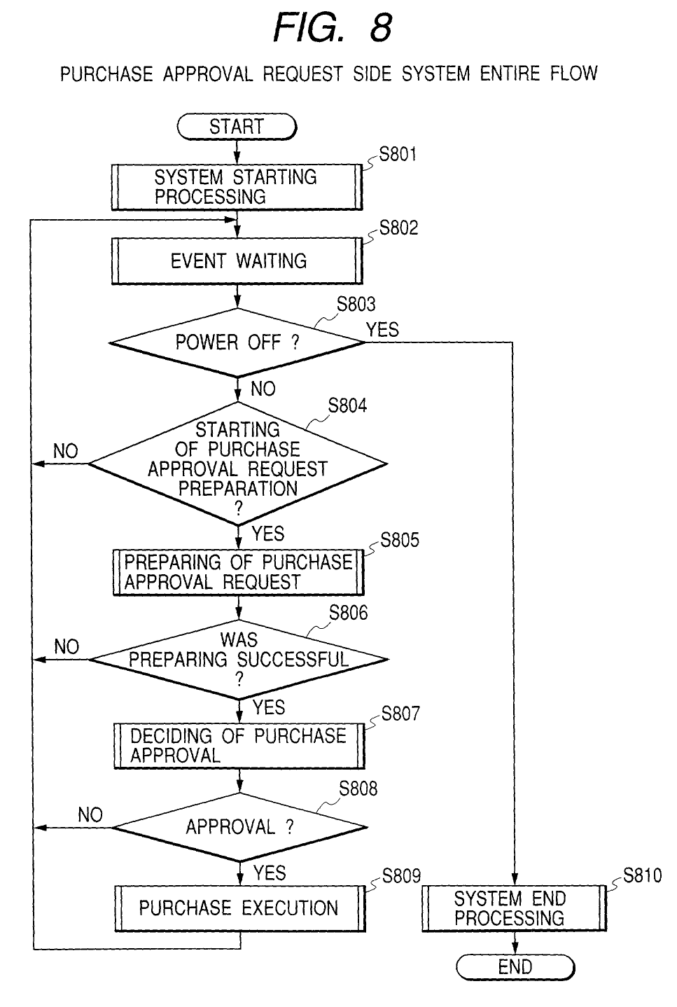

FIG. 8 is a flow chart showing the process of the entire system of the present embodiment. At first, when the system is activated, a system activation process in a step S801 initializes various devices and memories contained in the system.

Then a step S802 awaits generation of various events such as an input operation from the user, a reception of information from other devices, or a signal from a timer.

When any event is generated, a next step S803 discriminates whether the event instructs turning-off of the power supply, and, if so, a system ending process of a step S810 executes ending processes for the devices and memories in the system whereby the operation of the system is terminated.

In case the step S803 identifies that the event does not instruct the turning-off of the power supply, a next step S804 discriminates whether the event instructs to start preparation of a purchase approval request. If not, the sequence returns to the step S802 to repeat the above-explained process.

If the step S804 identifies that the event instructs the start of preparation of the purchase approval request, a next step S805 prepares a purchase approval request by a purchase approval request preparing process, and a step S806 discriminates whether the preparation is successful. If the preparation is not identified successful, the sequence returns to the step S802 to repeat the above-described process.

On the other hand, if the step S806 identifies that the preparation is successful, a next step S807 informs the approval service of thus prepared purchase approval request for deciding whether the purchase approval request is to be approved or not, and a next step S808 discriminates whether the request has been approved. If the request is not identified approved, the sequence returns to the step S802 to repeat the above-described process.

If the step S808 identifies that the request has been approved, a purchase execution process in a next step S809 executes a process matching the aforementioned purchase approval request, whereupon the sequence returns to the step S802 to repeat the above-described process. At the purchase execution process in the step S809 matching the purchase approval request, the execution of such process may also be informed, for example by e-mail, to the approval decider.

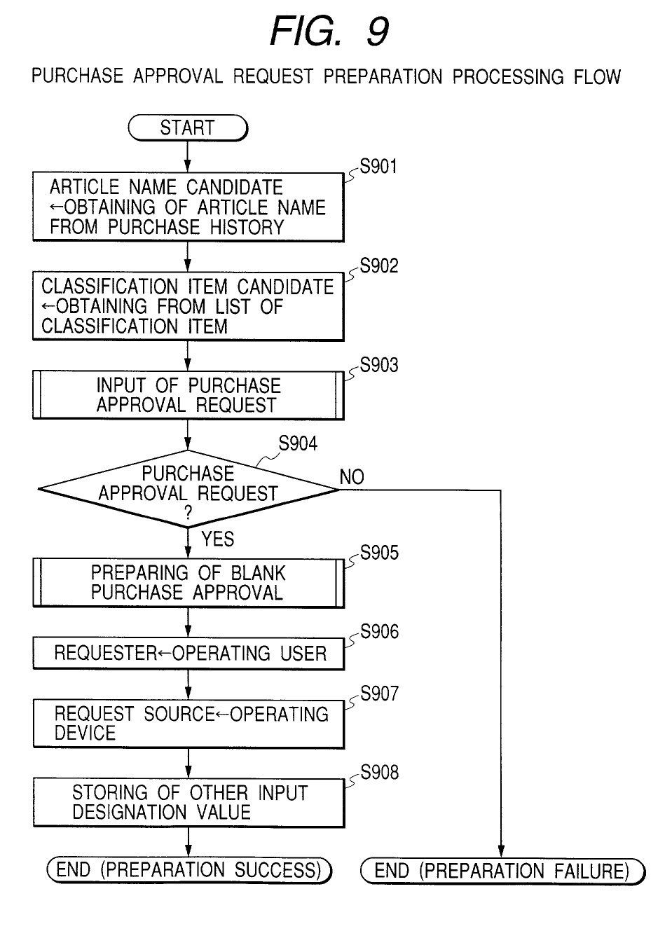

FIG. 9 is a view showing the flow of a purchase approval request preparing process of the step S805, in the process flow of the entire system shown in FIG. 8.

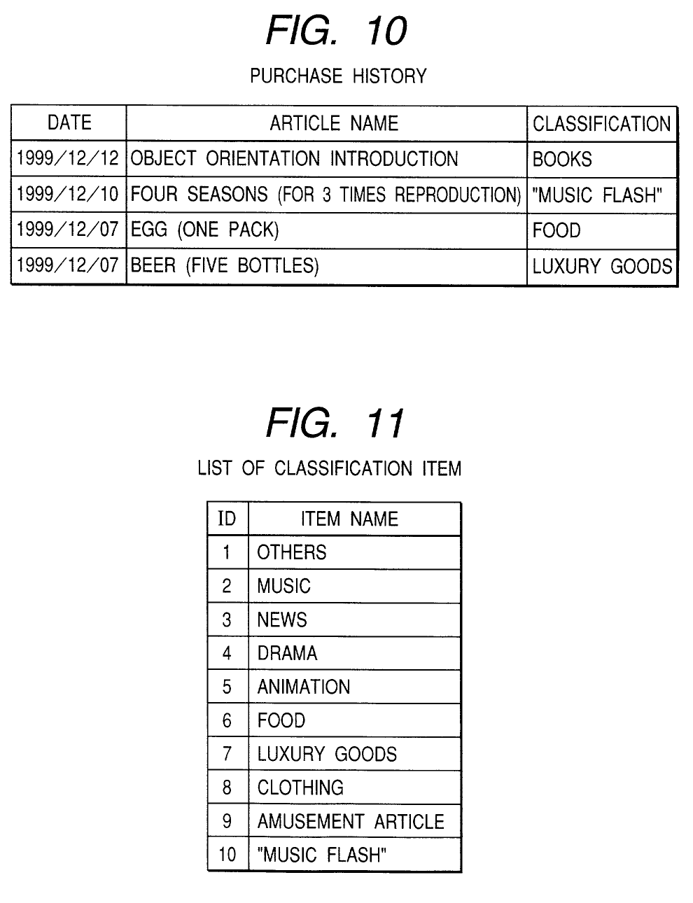

The purchase approval request preparing process in the information processing apparatus of the present embodiment receives an input operation from the user and prepares a purchase approval request. More specifically, when the purchase approval request preparing process is activated, a step S901 acquires a merchandise name from the purchase history in the past, and stores it as a candidate for the merchandise name. FIG. 10 shows an example of the purchase history including the date and time of purchase, merchandise name and classification thereof.

A next step S902 acquires a classification item from a list of classification items and stores it as a classification item candidate. FIG. 11 shows an example of the list of the classification items. The list of the classification items in the present information processing apparatus stores an ID and the name of a classification item corresponding to the ID.

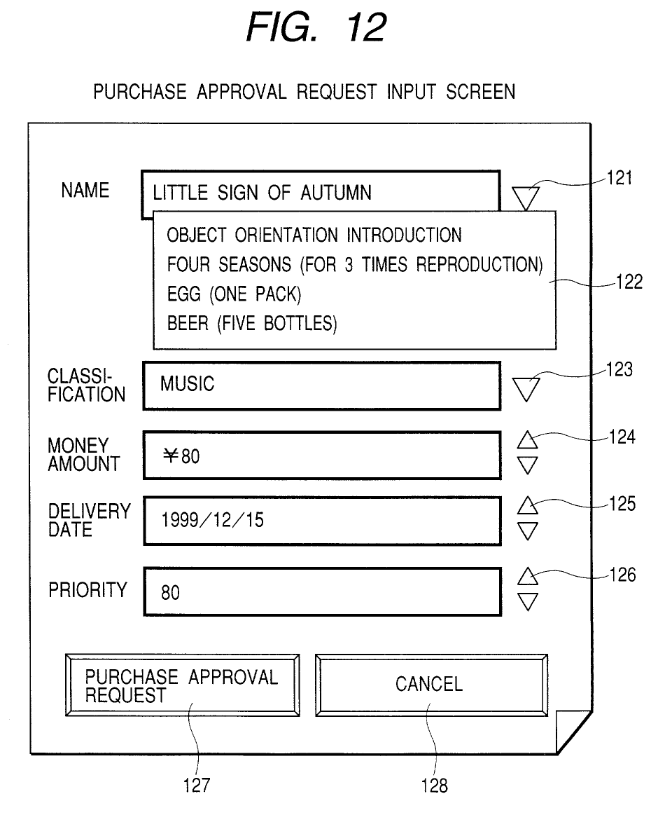

A next step S903 executes a purchase approval request input process of displaying an image for entering the purchase approval request (cf. FIG. 12) to be explained later utilizing the aforementioned merchandise name candidate and the classification item candidate, requesting and accepting the input operation of the user. A next step S904 discriminates whether the purchase approval request has been made, and, if the request is not identified present, the preparation of the purchase approval request is identified unsuccessful and the process is terminated.

If the step S904 identifies that the purchase approval request has been present, a next step S905 prepares an empty purchase approval request and steps S906 to S908 set parameters therefor. A step S906 sets the actually operating user as the requester of the purchase approval request, then a step S907 sets the actually operated device as the requesting source of the purchase approval request, and a step S908 stores various values entered by the user in the aforementioned purchase approval request input process as the purchase approval request, whereupon the preparation of the purchase approval request is completed successfully and the process is terminated.

FIG. 12 is a view showing an example of the purchase approval request input image to be displayed in the purchase approval request input process of the step S903 in the aforementioned purchase approval request preparation process, for receiving the merchandise name candidate and the classification item candidate and requesting and accepting the input by the user.

In the purchase approval request input image in the present information processing apparatus, there can be entered the name 121 of a merchandise constituting the object of the purchase approval request, classification 123, monetary amount 124, delivery date 125 and priority 126 thereof. It is also possible to display the merchandise name candidate and the classification item candidate stored in the steps S901 and S902 and to select the merchandise name and the classification item among such candidates.

After the above-described input and selecting operations by the user, the user can depress the purchase approval request execution button 127 or the cancellation button 128 to respectively execute or cancel the purchase approval request.

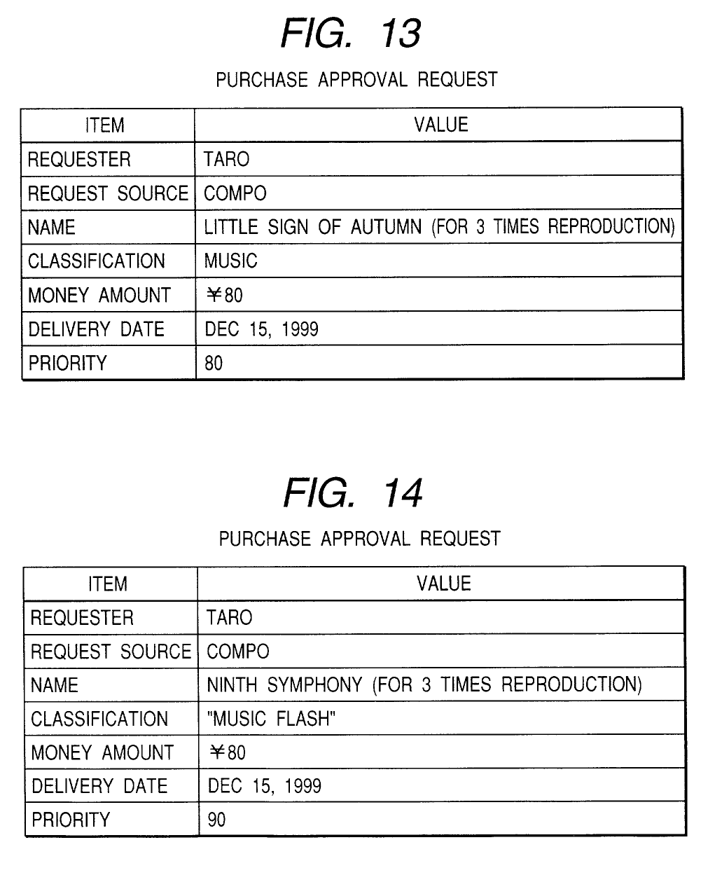

FIGS. 13 and 14 show examples of the purchase approval request prepared by the aforementioned purchase approval request preparing process (step S805).

The purchase approval request in the present information processing apparatus stores, for example, the requester executing the purchase approval request, the request source executing the operation, the name of merchandise, classification, monetary amount, delivery date and priority thereof. For example, FIG. 13 shows a purchase approval request prepared by a requester “Taro” from a request source “Compo”, for a merchandise name “Little Sign of Autumn (for reproductions of three times)” of a classification “music” with a monetary amount “¥80”, a delivery date “Dec. 15, 1999” and a priority “80”.

On the other hand, FIG. 14 shows a purchase approval request prepared by a requester “Taro” from a request source “Compo”, for a merchandise name “Ninth Symphony (for reproductions of three times)” of a classification “music flash” with a monetary amount “¥80”, a delivery date “Dec. 15, 1999” and a priority “80”.

FIG. 15 is a flow chart showing the flow of the purchase approval request deciding process in the step S807 in the aforementioned entire system flow.

In the purchase approval deciding process by the approval service stored in the present information processing apparatus, the purchase approval request is decided to be approved or not by searching and applying the approval decision information only in case the approval decision is identified necessary. More specifically, when the purchase approval decision process is activated, a purchase approval decision judging process in a step S1501 discriminates whether or not to perform the approval decision. If a next step S1502 does not identify that the approval decision is to be performed, the sequence proceeds to a step S1511 for executing a purchase rejection informing process of informing the requester of the rejection of the purchase approval request whereupon the process is terminated.

If the step S1502 identifies that the approval decision is to be performed, a step S1503 executes an approval decision information searching process to search approval decision information corresponding to the entered purchase approval request. As a result, if a next step S1504 does not identify that the search is successful, the sequence proceeds to a step S1511 for executing a purchase rejection informing process of informing the requester of the rejection of the purchase approval request whereupon the process is terminated.

On the other hand, if the step S1504 identifies that the search is successful, a next step S1505 executes an approval decision information applying process to apply the purchase approval request to the aforementioned approval decision information. If a next step S1506 does not identify that the application is successful, the sequence proceeds to a step S1511 for executing a purchase rejection informing process of informing the requester of the rejection of the purchase approval request whereupon the process is terminated.

If the step S1506 identifies that the application is successful, a next step S1507 discriminates whether confirmation by the approval decider is necessary. If it is identified that the confirmation is necessary, a step S1508 executes an approval confirmation process of informing the approval decider of the approval request and confirming if it is approved. If a next step S1509 does not identify that the request is approved, the sequence proceeds to a step S1511 for executing a purchase rejection informing process of informing the requester of the rejection of the purchase approval request whereupon the process is terminated.

In case the step S1507 identifies that the confirmation of the approval decider is unnecessary or the step S1509 identifies that the approval for the request is confirmed by the approval decider, a step S1510 executes a purchase approval informing process of informing the requester of the approval for the purchase approval request whereupon the process is regarded as approved and is terminated.

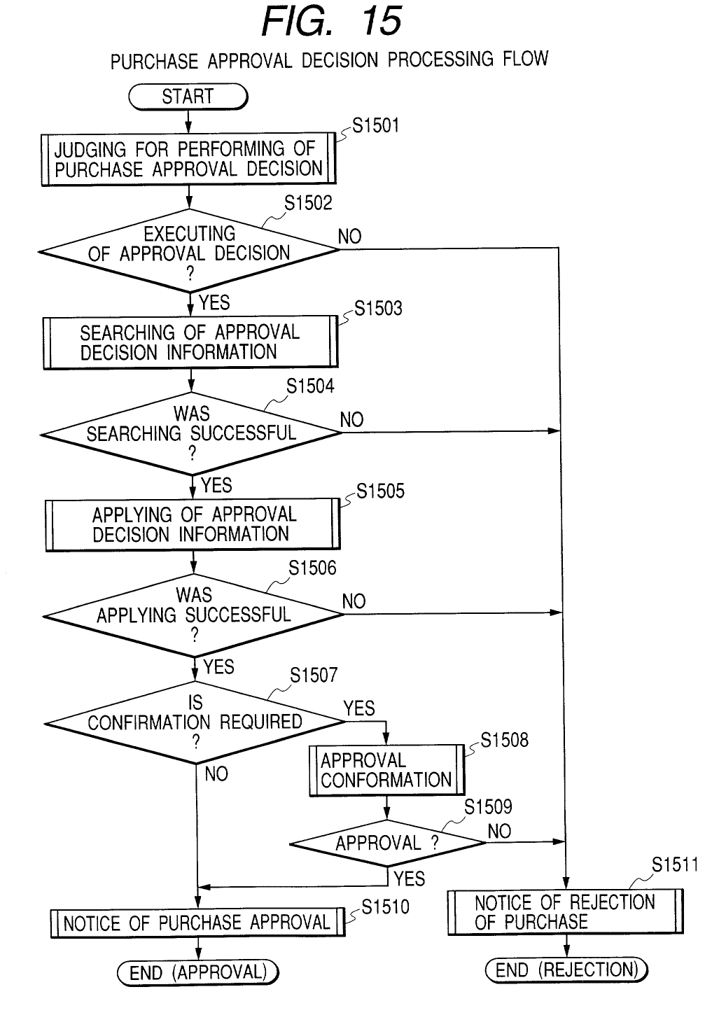

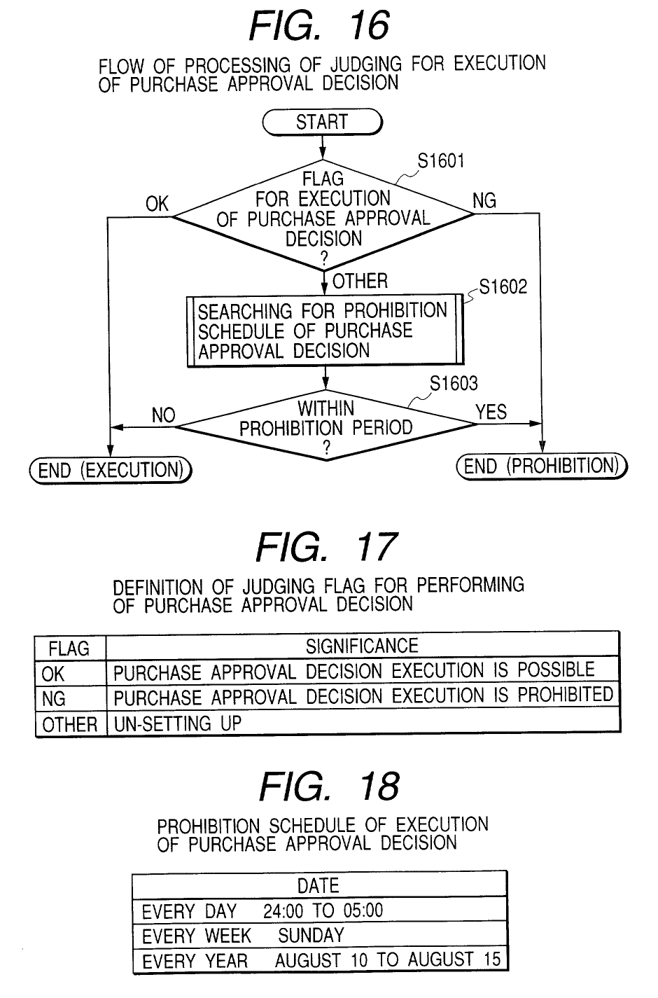

FIG. 16 is a flow chart showing the flow of the purchase approval decision judging process of the step S1501 in the aforementioned purchase approval decision process.

In the present embodiment, the purchase approval decision judging process discriminates whether or not to decide the approval by preferring to a purchase approval decision performing flag to be explained later and a purchase approval decision prohibiting schedule. More specifically, when the purchase approval decision judging process is activated, a step S1601 switches the judgment by referring to the purchase approval decision performing flag to be explained later. If the flag is “OK”, the purchase approval decision is to be performed whereupon the process is terminated. If the flag is “NG”, the purchase approval decision is to be prohibited whereupon the process is terminated.

If the purchase approval decision performing flag is otherwise, a next step S1602 executes a search process for the purchase approval decision prohibiting schedule for searching the current time in the purchase approval decision prohibiting period in the purchase approval decision prohibiting schedule to be explained later. As a result, if it is identified, in a next step S1603, that the current time is within the prohibiting period, the purchase approval decision is prohibited, but, if not within the prohibiting period, the purchase approval decision is to be performed.

In the above-described steps, the designation by the purchase approval decision performing flag is given priority in the judgment, and the purchase approval decision prohibiting schedule is referred to only in case such designation is not made.

FIG. 17 shows an example of the definition of the purchase approval decision performing flag to be referred to in the step S1601 in the aforementioned purchase approval decision judging process. In the purchase approval decision performing flag of the present information processing apparatus, “OK” indicates that the purchase approval decision is possible while “NG” indicates that the purchase approval decision is prohibited and others are still undefined.

FIG. 18 shows an example of the purchase approval decision prohibiting schedule to be referred to in the search process for the purchase approval decision prohibiting schedule in the step S1602 in the aforementioned purchase approval decision judging process.

In the purchase approval decision prohibiting schedule of the present information processing apparatus, time zones in which the purchase approval decision is prohibited are described as a list. Therefore, in the search process for the purchase approval decision prohibiting schedule of the present information processing apparatus, the search is made by checking whether the current time falls in the list.

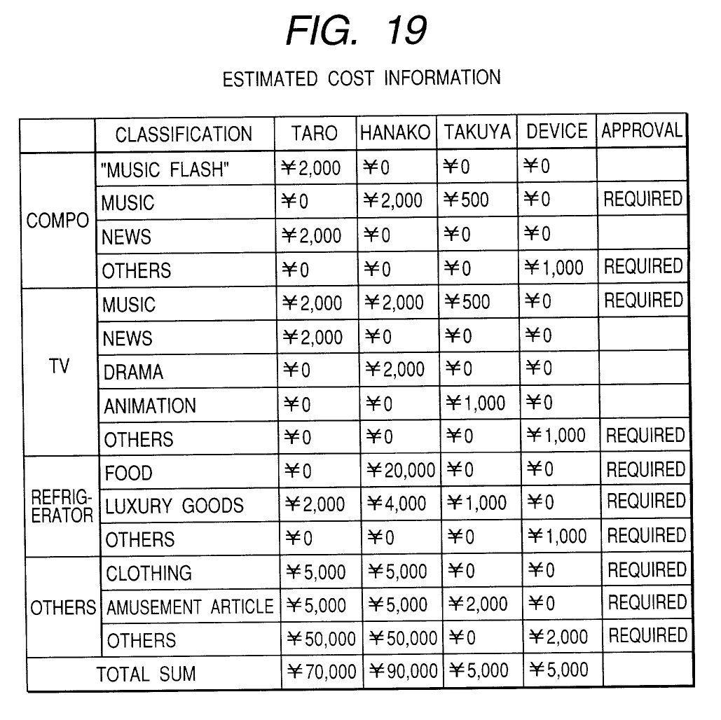

FIG. 19 shows an example of the estimated cost (budget) information to be used in the approval decision information applying process in the step S1505.

In the present information processing apparatus, the estimated cost information includes, for each device and for each classification, a personal budget, a budget for the device itself and data indicating whether the aforementioned approval confirmation (cf. step S1507) is necessary or not.

For example, for the classification “Music Flash” of a device “compo”, there is only secured a budge ¥2,000 for “Taro” without requiring approval confirmation. Also for the classification “music” for the device “compo”, there are secured a budget ¥2,000 for “Hanako” and ¥5,000 for “Takuya” which require approval confirmation.

In the following there will be explained, with reference to the foregoing drawings, a case of preparing a purchase approval request of the user, deciding the approval for purchase and executing the purchase within a single apparatus (or a single system).

When the start of preparation of a purchase approval request is instructed to the apparatus of the present embodiment as shown in FIG. 2, the step S804 shown in FIG. 8 identifies that the start of preparation of the purchase approval request has been instructed and the step S805 executes the purchase approval request preparing process to prepare the purchase approval request. For example, when the operating user “Taro” enters, in the operating device “compo”, a name “Small Signs of Autumn (for three reproductions)”, a classification “music”, a monetary amount “Y80”, a delivery date “Dec. 15, 1999” and a priority “80” and selects the purchase approval request button 127, there is prepared a purchase approval request as shown in FIG. 13.

As a result, the next step S806 identifies that the preparation of the purchase approval request is successful and the succeeding step S807 executes the purchase approval decision process to decide whether or not to approve the request.

In the purchase approval decision process, the approval decision information searching process of the step S1503, by referring to the budget information in FIG. 19, searches the classification “music” by the requesting device “compo”.

As a result, the next step S1504 identifies that the search is successful and the next step S1505 executes the approval decision information applying process to apply the requested amount ¥80 to the budget ¥0 of the requester “Taro”, but the application fails because of the shortage of the budget. Thus the step S1511 informs that the purchase is rejected and the process is terminated.

On the other hand, in case of a purchase approval request as shown in FIG. 14 with the requester “Taro” and the device “compo”, the search is executed for the classification “Music Flash” and there is tried to apply the requested amount ¥80 to the budget ¥2,000 of the requester “Taro”. The attempt is successful since the requested amount can be accommodated in the budget. Then the step S1507 discriminates the necessity of approval confirmation, and identifies that the approval confirmation is unnecessary because it is not designated as “necessary”. Thus the step S1510 informs that the purchase is approved and the process is terminated.

In the foregoing there has been explained a case where the preparation of the purchase approval request and the approval decision are executed within a single apparatus, but a similar process can naturally be executed not only in an apparatus but also in a closed single system or in a closed processing system.

As explained in the foregoing, the present embodiment 1 allows to avoid the drawback of the prior art, requiring a long time in case the approval decider is busy, since the decision of the approval is performed in the client apparatus (or client system) used by the approval requester by referring to the “information necessary for purchase approval decision” set in advance.

Also the step S1510 executes the purchase approval decision performing process in advance, thereby avoiding a drawback that the approval decision is automatically performed within an approval decision prohibiting period such as during the night.

(Embodiment 2)

In the embodiment 1, the conditions for performing the approval service are set in advance in the client terminal as shown in FIG. 2.

In the present embodiment 2, all the information for the purchase approval decision is not prepared in advance but, whenever the purchase approval request of a new field appears, a corresponding approval service is registered thereby avoiding that the system becomes complex and bulky.

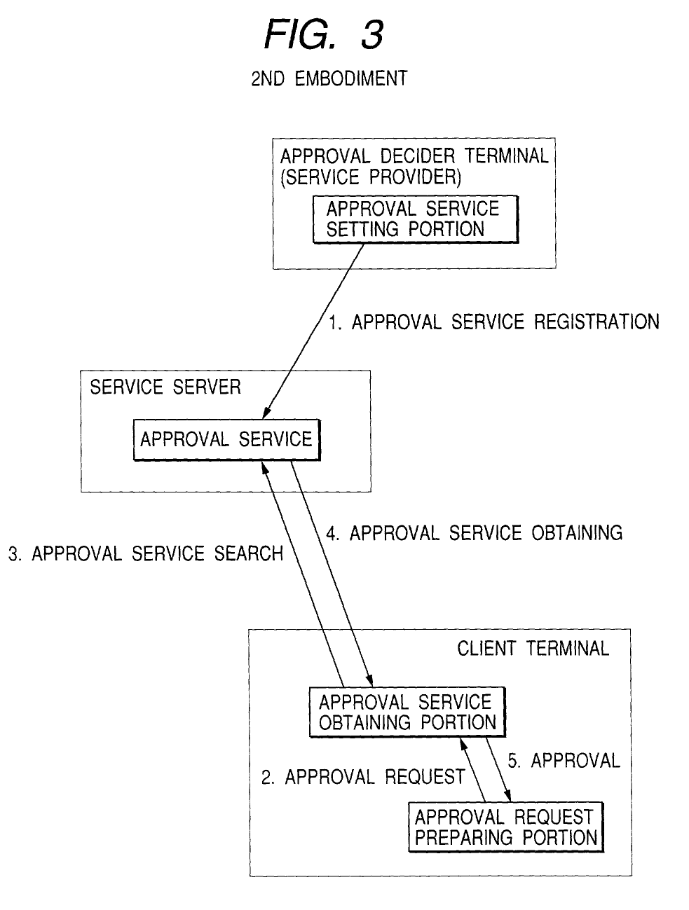

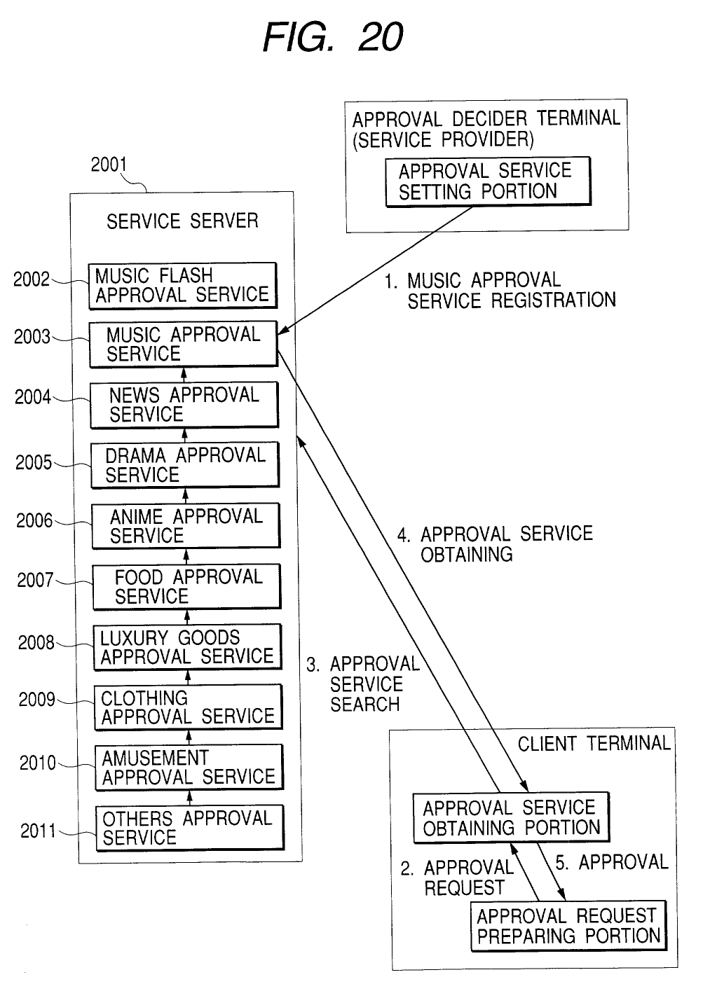

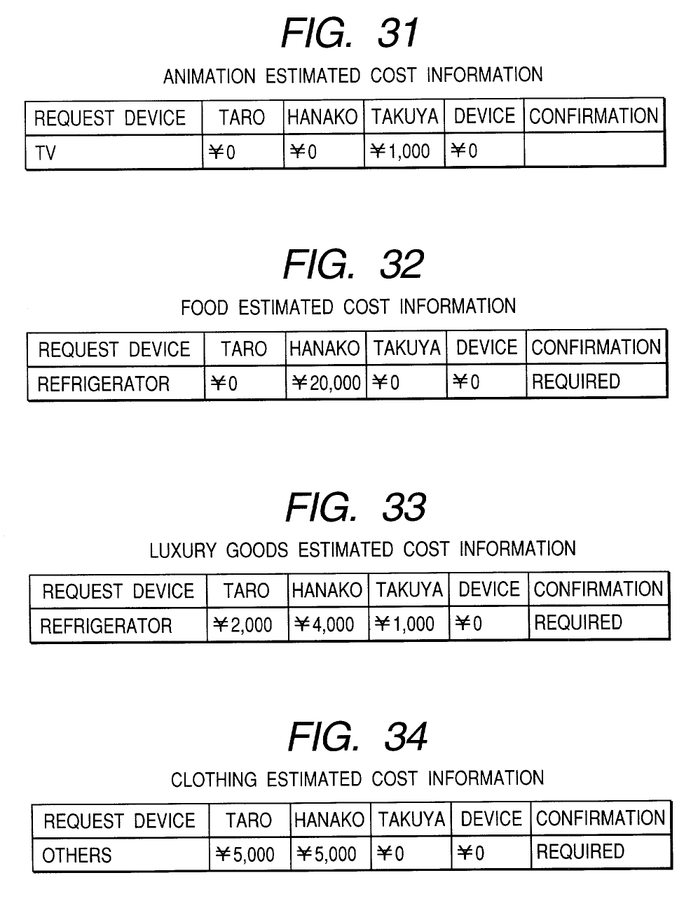

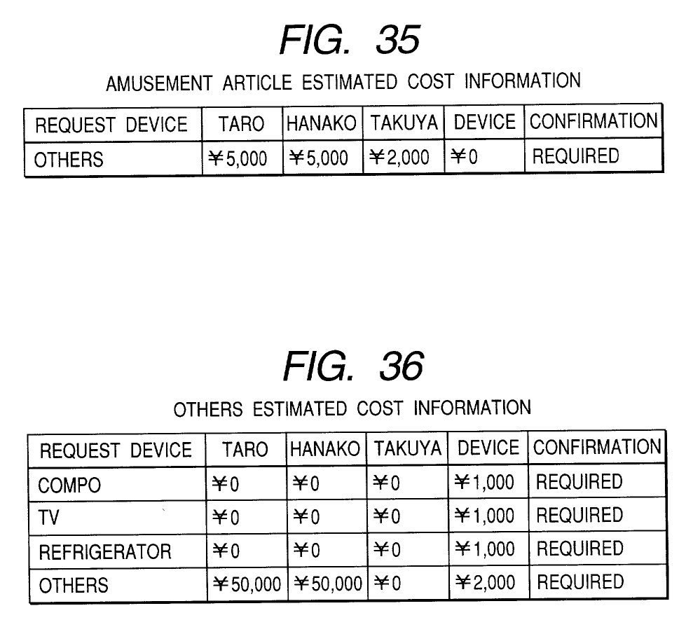

Thus, in the embodiment 2, the service server is given a function of registering, deleting and renewing the approval service as shown in FIG. 3, and, whenever an approval service is required in the client apparatus, such approval service is searched and acquired, among those held by the service server, for performing the approval service decision. Such process will be explained in more details in the following with reference to FIGS. 20 to 36.

FIG. 20 shows the details of the relationship among a client terminal used by the purchase approval requester, a decider terminal used by the purchase approval decider and a service server for registering and managing the purchase approval services. In a service server 2001 there are registered various approval services (2002 to 2011).

The process is executed in the following flow.

1. The service provider registers a “music approval service” in the service server 2001. Thus a music approval service 2003 is added to the service server 2001.

2. A purchase approval request is prepared in the client terminal according to an instruction from the user.

3. In order to perform the approval decision, an approval service corresponding to the approval request is searched in the service server 2001.

4. As a result of such search, the client terminal acquires the searched approval service.

5. Utilizing the acquired approval service, the client terminal judges the approval request in the same manner as in the embodiment 1.

FIG. 20 shows as if the approval service itself is directly stored in the service server 2001, but there may only be stored information for accessing to the main part of the approval service present in another device.

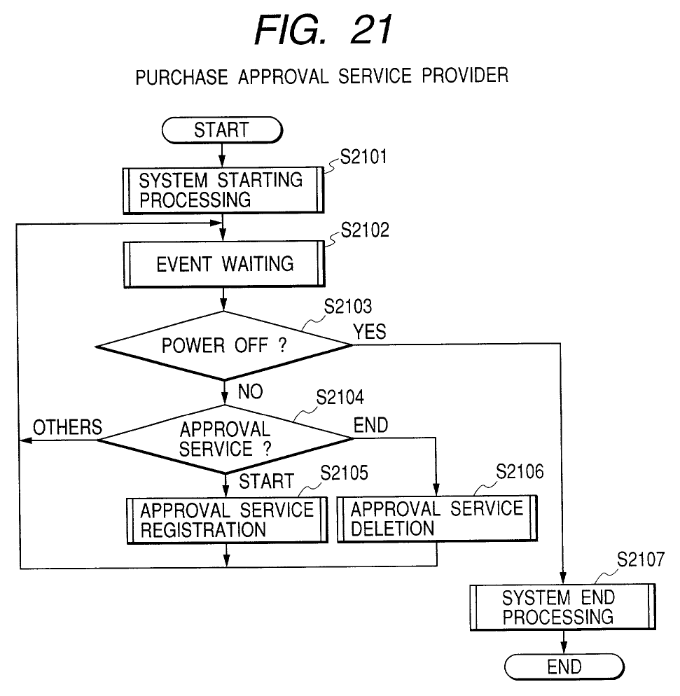

FIG. 21 shows the process to be performed by the terminal (purchase approval service provider) to be used by the purchase decider. More specifically, when the purchase approval service provider is activated, a step S2101 executes an initializing process for initializing various devices and memories of the system. Then a step S2102 awaits generation of various events such as an input operation from the user, a reception of information from other devices, or a signal from a timer.

When any event is generated, a next step S2103 discriminates whether the event instructs turning-off of the power supply, and, if so, a system ending process of a step S2107 executes ending processes for the devices and memories in the system whereby the operation of the system is terminated.

In case the step S2103 identifies that the event does not instruct the turning-off of the power supply, a next step S2104 discriminates whether the event is an instruction for the approval service. If not, the sequence returns to the step S2102.

If the step S2104 identifies that the event instructs the start of an approval service, a step S2105 performs an approval service registration process to register the approval service in the service server 2001, whereupon the sequence returns to the step S2102.

If the step S2104 identifies that the event instructs the end of an approval service, a step S2106 performs an approval service deletion process to delete the approval service from the service server 2001, whereupon the sequence returns to the step S2102.

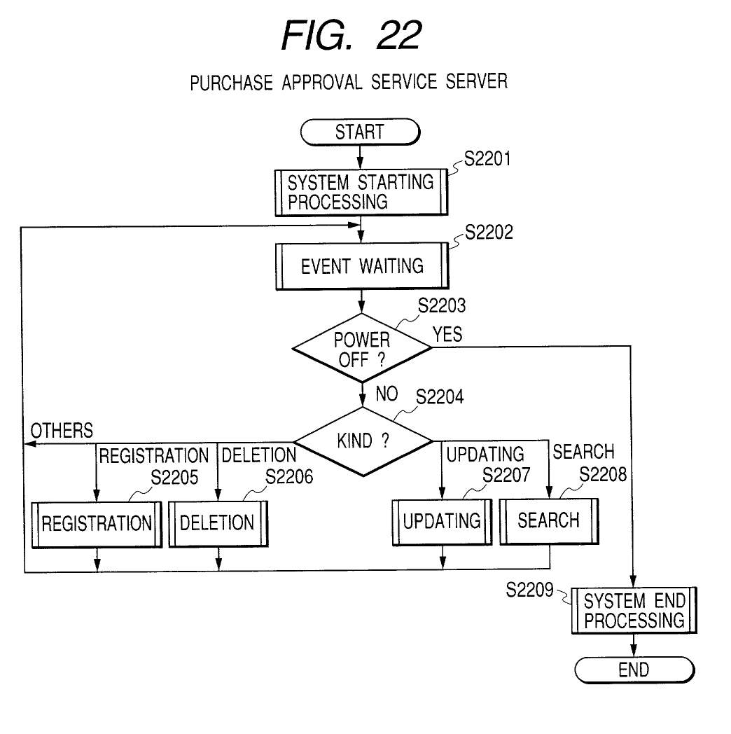

FIG. 22 shows the process of the entire purchase approval service server for registering and managing the purchase approval service. More specifically, when the purchase approval service server is activated, a step S2201 executes a system initializing process for initializing various devices and memories of the system. Then a step S2202 awaits generation of various events such as an input operation from the user, a reception of information from other devices, or a signal from a timer.

When any event is generated, a next step S2203 discriminates whether the event instructs turning-off of the power supply, and, if so, a system ending process of a step S2209 executes ending processes for the devices and memories in the system whereby the operation of the system is terminated.

In case the step S2203 identifies that the event does not instruct the turning-off of the power supply, a next step S2204 discriminates the type of the event. As a result, if it is not identified as an instruction for the approval service, the sequence returns to the step S2202.

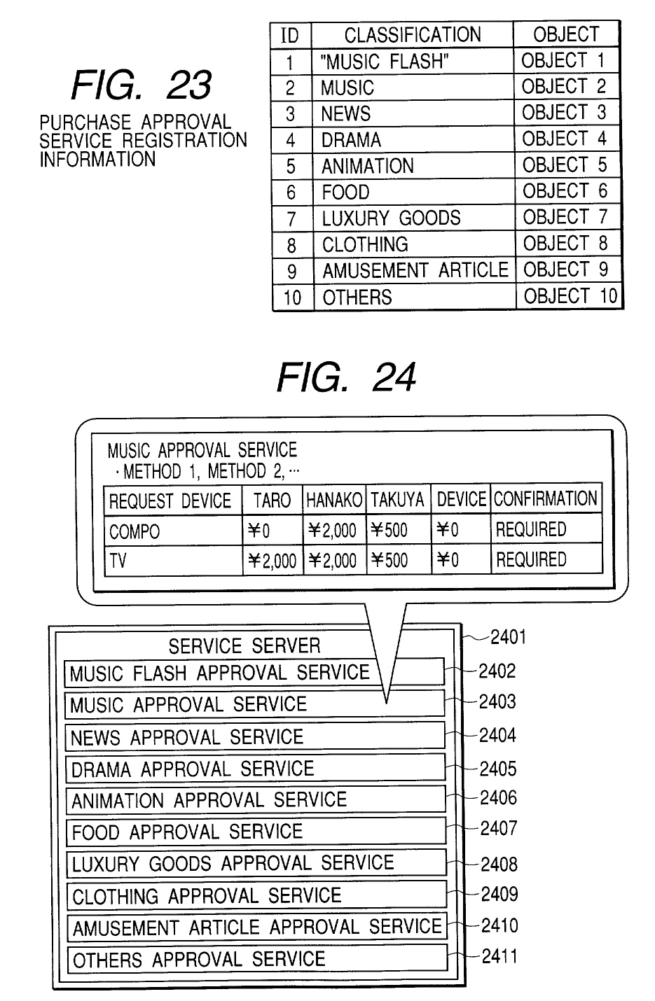

If the step S2204 identifies that the event instructs the registration of an approval service, a step S2205 performs an approval service registration process to register the approval service, transmitted from the service provider, as approval service registration information (cf. FIG. 23), whereupon the sequence returns to the step S2202.

If the step S2204 identifies that the event instructs the deletion of an approval service, a step S2206 performs an approval service deletion process to delete the designated approval service from the approval service registration information, whereupon the sequence returns to the step S2202.

If the step S2204 identifies that the event instructs the renewal of an approval service, a step S2207 performs an approval service renewal process to renew the approval service, stored as the approval service registration information, whereupon the sequence returns to the step S2202.

If the step S2204 identifies that the event instructs the search of an approval service, a step S2208 performs an approval service search process to search the corresponding approval service from the approval service registration information and to transfer it to the search requesting source, whereupon the sequence returns to the step S2202.

FIG. 23 shows an example of the purchase approval service registration information registered and referred in the purchase approval service server 2001.

In the present information processing apparatus, the purchase approval service registration information includes an ID representing each purchase approval service, a classification thereof and an object.

The object may be the purchase approval service itself, or only information required in the purchase approval service, or information for accessing to the purchase information service present in another device.

FIG. 24 shows an example of the object of the purchase approval service stored in the aforementioned purchase approval service registration information, and specifically shows an example of music approval service in detail. More specifically, the object of the purchase approval service is provided with a method for realizing the service and conditional data for the approval decision, and the service is provided by combining these data.

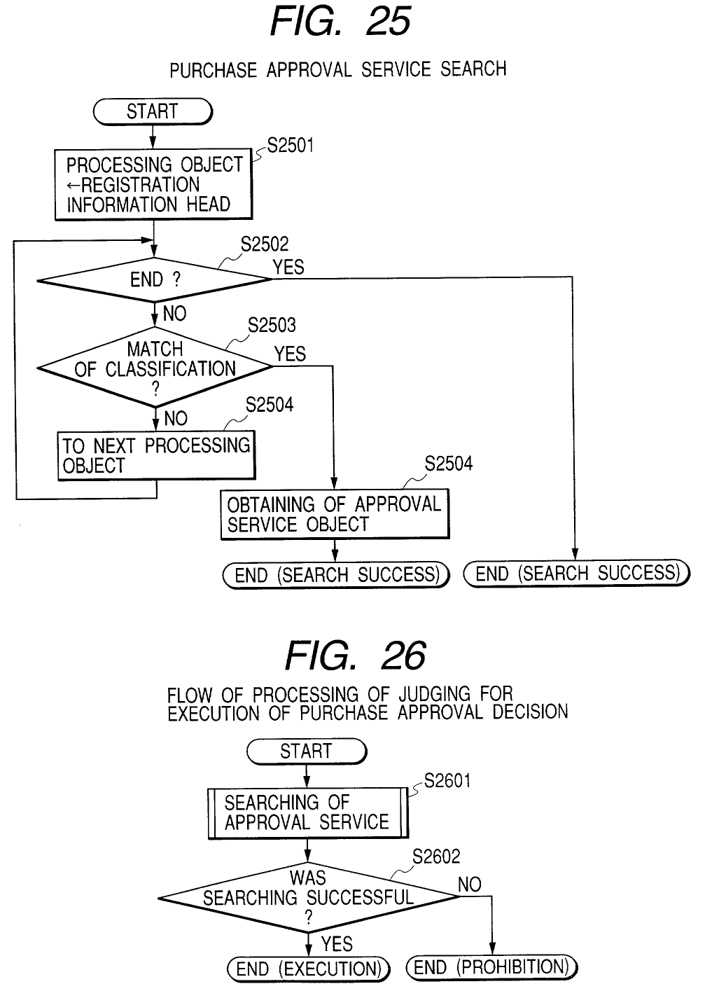

FIG. 25 is a view showing the flow of a purchase approval service searching process in the step S2208 shown in FIG. 22.

In the approval service server, the purchase approval service search process searches the corresponding approval service from the aforementioned service registration information and transfers it to the client terminal constituting the request source. More specifically, when the purchase approval service search process is activated, a step S2501 initializes the object of process at the head of the aforementioned purchase approval service registration information, and a next step S2502 discriminates whether the object of process has been terminated. As a result, if the process is identified to have been completed for all the aforementioned purchase approval service registration information, the search is regarded as a failure and the process is terminated.

If the step S2502 identifies that the process has not yet been completed, a next step S2503 discriminates whether the classification of the aforementioned purchase approval request given as the search condition coincides with that of the purchase approval service registration information. In case of coincidence, a step S2505 acquires the approval service object having such coinciding classification and transfers it to the client terminal of the requesting source, whereupon the search is regarded as a success and the process is terminated.

In case the step S2503 identifies that the classification does not coincide, a next step S2504 advances the object of process to the next approval service registered in the approval service registration information and the sequence returns to the step S2502.

The client terminal executes the process shown in FIG. 15 as in the embodiment 1, but, in the present embodiment 2, the judging process in the step S1501 executes a process shown in FIG. 26.

In the present embodiment 2, the decision of approval is judged according to the result of search for the purchase approval service corresponding to the purchase approval request, from the aforementioned purchase approval service server.

More specifically, when the purchase approval decision performing processing is activated, a step S2601 executes a purchase approval service searching process for requesting the search for the purchase approval service corresponding to the purchase approval request to the service server and acquiring the search result from the service server. As a result, if a next step S2602 identifies that the search is successful, the purchase approval decision is performed and the process is terminated.

On the other hand, if the step S2602 identifies that the search is not successful, the purchase approval decision is regarded prohibited and the process is terminated.

The above-described steps allow to switch whether or not to perform the purchase approval decision according to whether the purchase approval service is registered in the purchase approval service server.

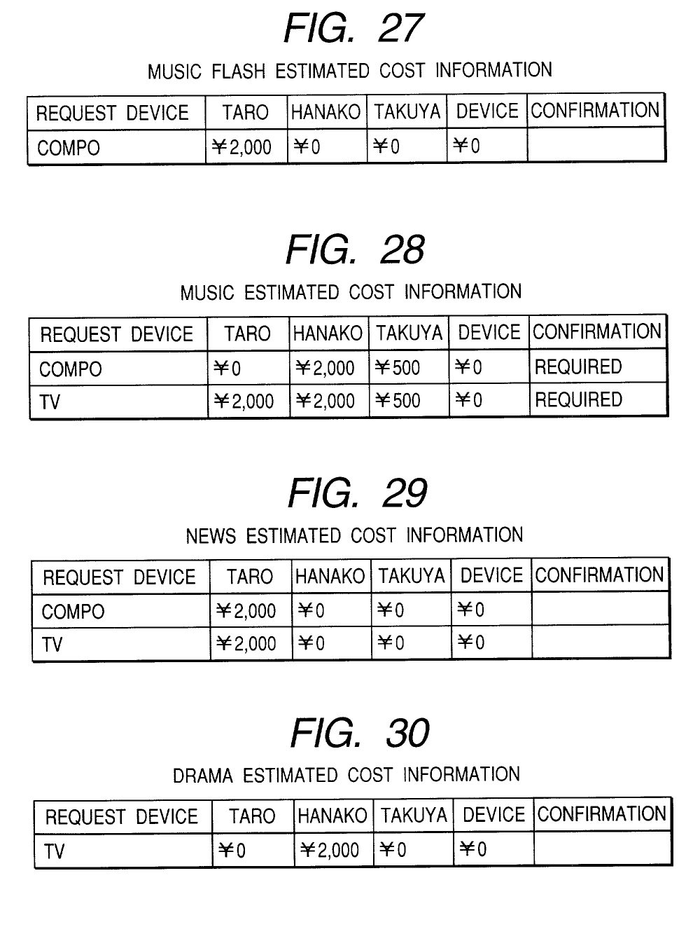

FIGS. 27 to 36 show examples of budget information (one of approval decision information) to be searched in the purchase approval service searching process of the step S2601 in FIG. 26 and to be applied in the approval decision information applying process of the step S1505 in FIG. 15.

More specifically, as shown in FIG. 24, each budget information constitutes a part of the respective approval service. For example, the “Music Flash budget information” constitutes a part of the “Music Flash approval service”, and such relationship also stands for the budget information shown in FIGS. 28 to 36. Also in the present information processing apparatus, each budget information (cf. FIGS. 27 to 36) stores, for each requesting device, a personal budget, a budget for the device itself and data indicating whether the approval confirmation is necessary or not (cf. step S1508 in FIG. 15).

In the following there will be explained, with reference to the foregoing drawings, a case of preparing a purchase approval request of the user, judging the purchase approval and performing the purchase in an environment utilizing the service server.

As already shown in FIG. 20, when the start of the “music purchase approval service” is instructed by the purchase approval service provider used by the purchase approval decider, the step S2105 shown in FIG. 20 performs the purchase approval service registration process to register the “music purchase approval service”, as indicated by 2003 in FIG. 20, in the service server 2001.

Also as shown in FIG. 20, when the start of preparation of the purchase approval request is instructed in the client terminal by the purchase approval requester, the step S805 shown in FIG. 8 performs the purchase approval request preparing process to prepare the purchase approval request.

For example, when the operating user “Taro” enters, in the operating device “compo”, a name “Small Signs of Autumn (for three reproductions)”, a classification “music”, a monetary amount “¥80”, a delivery date “Dec. 15, 1999” and a priority “80” and selects the purchase approval request button 127 as shown in FIG. 12, there is prepared a purchase approval request as shown in FIG. 13.

As a result, the next step S806 identifies that the preparation of the purchase approval request is successful and the succeeding step S807 executes the purchase approval decision process to decide whether or not to approve the request. In the purchase approval decision process shown in FIG. 15, the purchase approval decision performing process of the step S1501 searches the purchase approval service corresponding to the above-mentioned purchase approval request from the purchase approval service registration information registered in the service server shown in FIG. 23.

In case of the above-mentioned purchase approval request, the client terminal acquires the “music approval service” searched corresponding to the classification “music”. Then the approval decision information searching process of the step S1503 (cf. FIG. 15) refers to the budget information shown in FIG. 28, thereby searching the requesting device “compo”. As a result, the next step S1504 identifies that the search is successful and the next step S1505 executes the approval decision information applying process to apply the requested amount ¥80 to the budget ¥0 of the requester “Taro”, but the application fails because of the shortage of the budget. Thus the step S1511 informs that the purchase is rejected and the process is terminated.

On the other hand, in case of a purchase approval request as shown in FIG. 14, the client terminal acquires “Music Flash approval service” searched corresponding to the classification “Music Flash”. Then the approval decision information searching process of the step S1503 (cf. FIG. 15) refers to the budget information shown in FIG. 27 to search the requesting device “compo” and there is tried to apply the requested amount ¥80 to the budget ¥2,000 of the requester “Taro”. The attempt is successful since the requested amount can be accommodated in the budget. Then the step S1507 discriminates the necessity of approval confirmation, and identifies that the approval confirmation is unnecessary because it is not designated as “necessary”. Thus the step S1510 informs that the purchase is approved and the process is terminated.

It is also possible to provide means for informing a change in the approval decision information.

As explained in the foregoing, the present embodiment 2 allows to avoid the drawback of the prior art, requiring a long time for obtaining the approval in case the approval decider is busy, since the decision is performed by acquiring the approval service registered in the service server, and also avoid the necessity of registering many approval services in the client terminal.

Also the operation can be made more flexible by utilizing the registration, deletion, renewal and search processes in the service server. For example it is possible to avoid trouble resulting from the automatic approval of an important approval request while the approval decider is unaware of, for example by registering the approval service while the approval decider is in his seat and deleting the approval service when the approval decider goes back to home.

It is also possible to utilize a card reader as the terminal to be used by the approval decider. For example it is possible to utilize a card reader and a card in which the approval service is registered in the service server in response to an event of inserting a card storing the information of an approval service defining the classification of the object of approval and the budget therefor into a card reader, and the approval service is deleted from the service server when the card is extracted from the card reader. In such case, it is also possible to store information for specifying the corresponding approval service in the card instead of directly storing the corresponding approval service in the card.

It is furthermore possible, in each case, to add information necessary for identification.

(Embodiment 3)

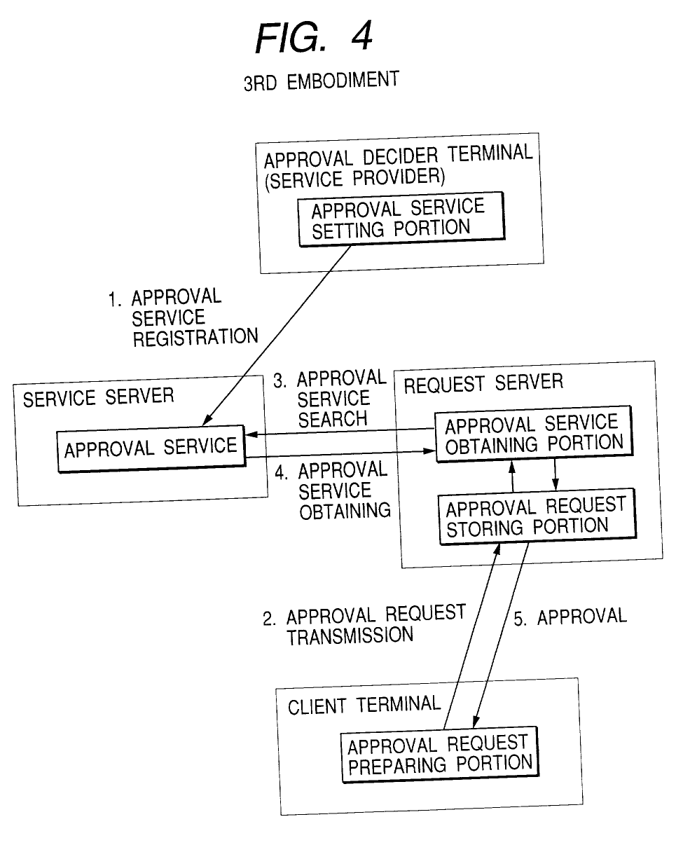

In the present embodiment 3, the preparation of the purchase approval request and the approval deciding process are separated as shown in FIG. 4 to enable more flexible operation.

In the present embodiment 3, the approval request prepared in the client terminal is registered in a request server and the approval decision process is performed therein. Also such flexible operation is realized by providing the request server with functions of registering, deleting, renewing and searching the approval request. Also plural approval requests can be processed in collective manner since the approval request can be registered in the request server.

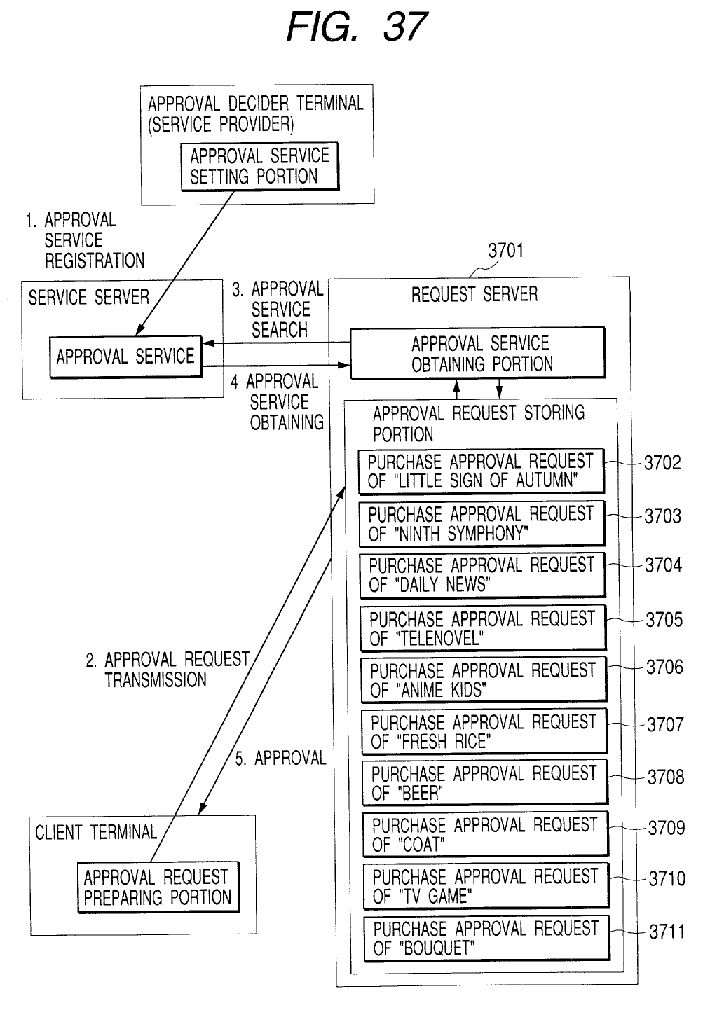

FIG. 37 shows the relationship among the client terminal to be used by the purchase approval requester, the approval decider terminal to be used by the purchase approval decider, the request server for registering and managing the purchase approval request, and the service server for registering and managing the approval service, as shown in FIG. 4, particularly an example of the purchase approval request stored in the request server.

More specifically, the process is executed in the following flow.

1. As in the embodiment 2, the service provider registers an “approval service” in the service server.

2. An approval request prepared in the client terminal is registered in the request server 3701.

3. In order to perform the approval decision for the registered purchase approval request, the request server 3701 searches an approval service corresponding to the approval request at an appropriate timing from the service server.

4. As a result of such search, the request server 3701 acquires the searched approval service.

5. Utilizing the acquired approval service, the request server 3701 judges the approval request and sends the result of judgment to the client terminal of the request source of the purchase approval request.

FIG. 37 shows as if the approval request itself is directly stored in the request server, but there may be stored information for accessing to the main part of the approval request present in another device.

Also the result of judgment on the approval may be sent to the approval decider in addition to the approval requester.

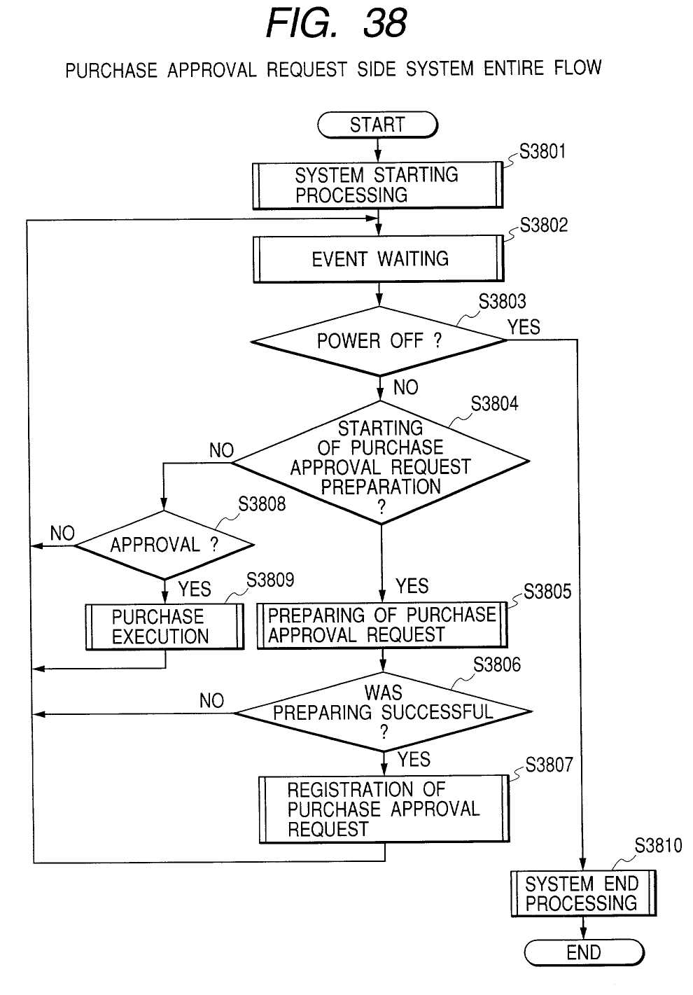

FIG. 38 is a flow chart showing the process in the client terminal for preparing the purchase approval request. More specifically, when the system is activated, a step S3801 executes an initializing process for initializing various devices and memories of the system.

Then a step S3802 awaits generation of various events such as an input operation from the user, a reception of information from other devices, or a signal from a timer.

When any event is generated, a next step S3803 discriminates whether the event instructs turning-off of the power supply, and, if so, a system ending process of a step S3810 executes ending processes for the devices and memories in the system whereby the operation of the system is terminated.

In case the step S3803 identifies that the event does not instruct the turning-off of the power supply, a next step S3804 discriminates whether the event instructs the start of preparation of a purchase approval request purchase approval request purchase approval request.

If the step S3804 identifies that the event instructs the start of preparation of a purchase approval request, a next step S3805 performs a purchase approval request preparing process to prepare a purchase approval request, and a next step S3806 discriminates whether the preparation is successful. If the preparation is not identified successful, the sequence returns to the step S3802.

If the step S3806 identifies that the preparation is successful, a next step S3807 performs a purchase approval request registering process to register the prepared purchase approval request in the request server 3701, whereupon the sequence returns to the step S3802.

If the step S3804 does not identify that the event instructs the start of preparation of the purchase approval request, a next step S3808 discriminates whether the event is a purchase approval event transmitted from the request server 3701. As a result, if the approval is not identified as decided, the sequence returns to the step S3802.

If the step S3808 identifies that the approval is decided, a next step S3809 performs a purchase performing process to perform a process corresponding to the aforementioned purchase approval request whereupon the process returns to the step S3802.

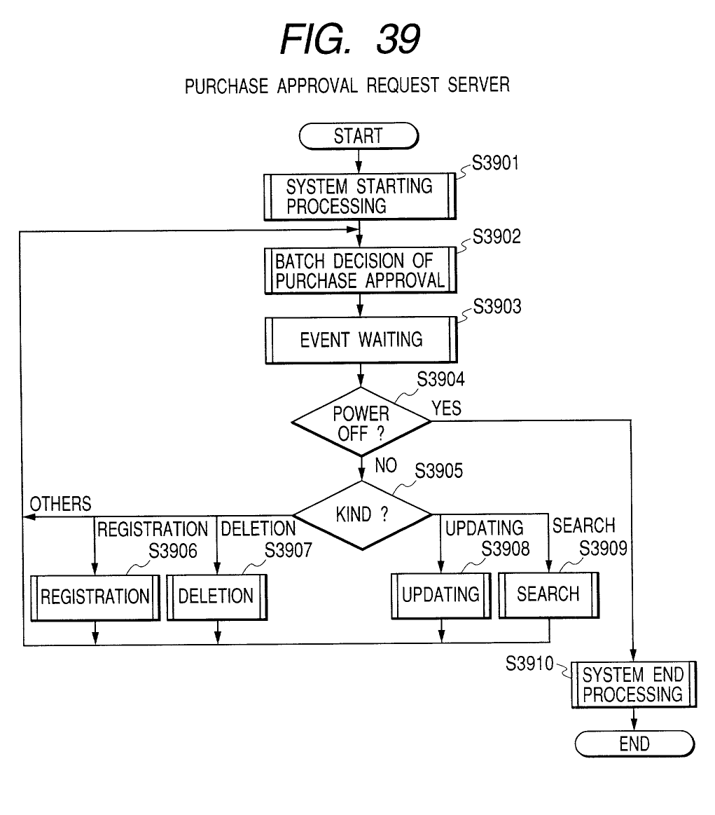

FIG. 39 shows the process in the purchase approval request server for managing the purchase approval service. More specifically, when the purchase approval request server is activated, a step S3901 executes a system initializing process for initializing various devices and memories of the system. Then a step S3902 executes a purchase approval collective decision process to perform approval decision on all the purchase approval requests stored as purchase approval request registration information to be explained later, and informs the result to the requester of the request source.

Then a next step S3903 awaits generation of various events such as an input operation from the user, a reception of information from other devices, or a signal from a timer. When any event is generated, a next step S3904 discriminates whether the event instructs turning-off of the power supply, and, if so, a system ending process of a step S3910 executes ending processes for the devices and memories in the system whereupon the operation of the system is terminated.

In case the step S3904 identifies that the event does not instruct the turning-off of the power supply, a next step S3905 discriminates the type of the event. As a result, if it is not identified as an instruction for the approval request, the sequence returns to the step S3902.

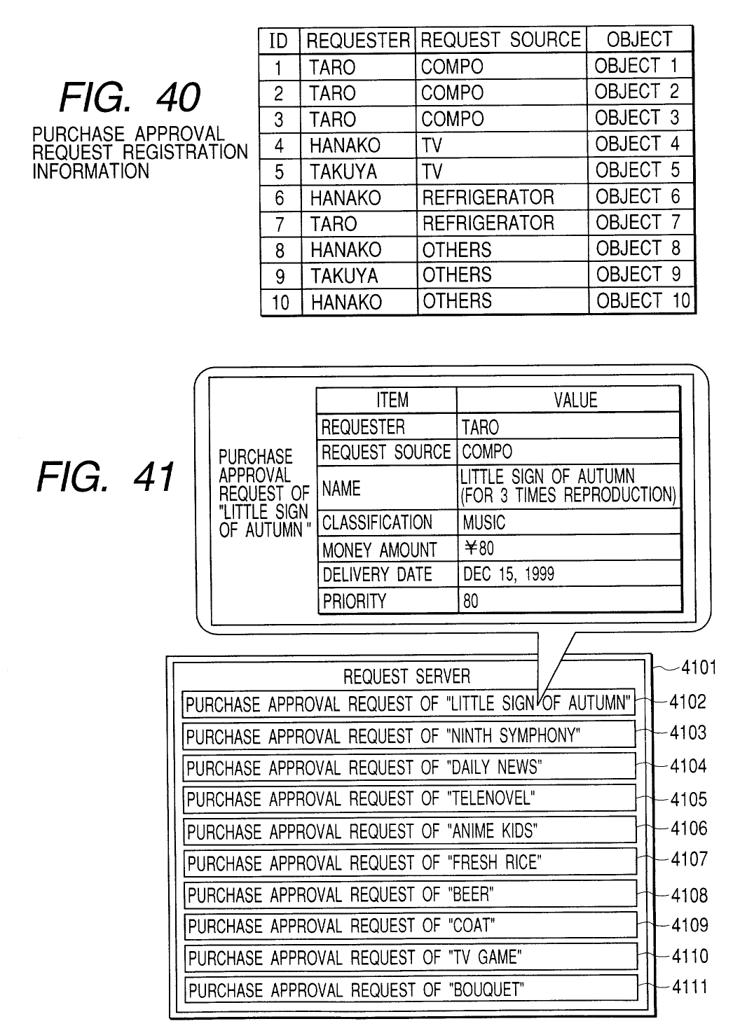

If the step S3905 identifies that the event instructs the registration of an approval request, a step S3906 performs an approval request registration process to register the approval request, transmitted from the client, as approval request registration information (cf. FIG. 40), whereupon the sequence returns to the step S3902.

If the step S3905 identifies that the event instructs the deletion of an approval request, a step S3907 performs an approval request deletion process to delete the designated approval request from the approval request registration information, whereupon the sequence returns to the step S3902.

If the step S3905 identifies that the event instructs the renewal of an approval request, a step S3908 performs an approval request renewal process to renew the approval request, stored as the approval request registration information, whereupon the sequence returns to the step S3902.

If the step S3905 identifies that the event instructs the search of an approval request, a step S3909 performs an approval request search process to search the corresponding approval request from the approval request registration information and to transfer it to the search requesting source, whereupon the sequence returns to the step S3902.

FIG. 40 shows an example of the purchase approval request registration information referred to in the purchase approval collective decision process of the step S3902 in FIG. 39.

In the present information processing apparatus, the purchase approval request registration information includes an ID representing each purchase approval request, a requester and a request source thereof, and an object. The object may be the purchase approval request itself, or only information required for accessing to the purchase information request present in another device.

FIG. 41 shows an example of the object of the purchase approval request stored in the purchase approval request registration information shown in FIG. 40, and specifically shows an example of purchase approval request for “Small Signs of Autumn” in detail. More specifically, the object of the purchase approval request is provided with data of purchase approval request such as name, classification, monetary amount etc.

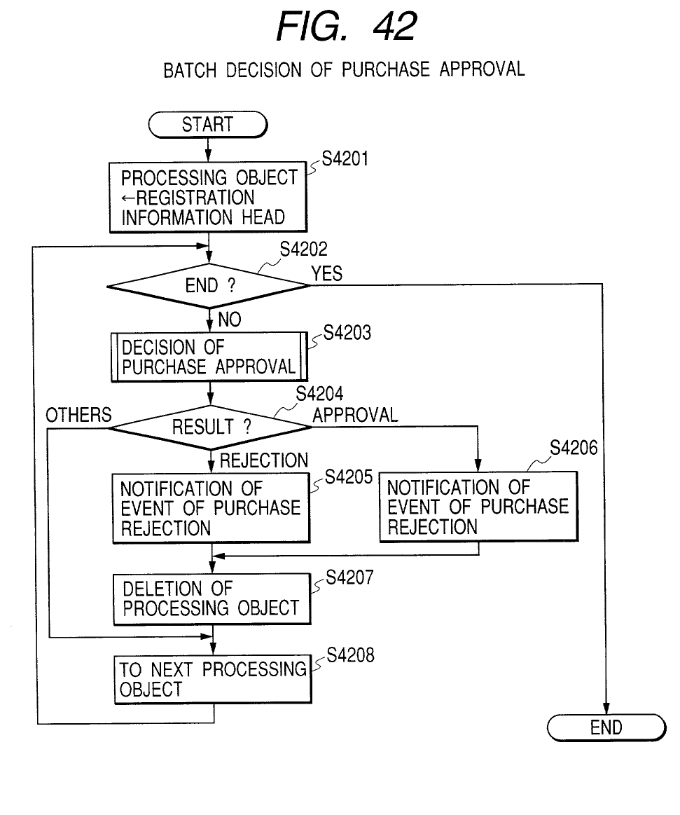

FIG. 42 is a flow chart showing the purchase approval collective decision process in the step S3902 shown in FIG. 39.

In the present embodiment, the purchase approval collective decision process is activated when a predetermined time is reached or when the approval requests are registered in a predetermined number. When the purchase approval collective decision process is activated, the approval decision is performed for all the purchase approval requests stored in the purchase approval request registration information, and the result is informed to the requester at the request source.

More specifically, when the purchase approval collective decision process is activated, a step S4201 initializes the object of process at the head of the aforementioned purchase approval request registration information, and a next step S4202 discriminates whether the object of process has been terminated. As a result, if the process is identified to have been completed for all the purchase approval request registration information, the process is terminated.

If the step S4202 identifies that the process has not yet been completed, a next step S4203 performs the purchase approval deciding process for judging whether or not to approve the purchase approval request of the object of process. Then a step S4204 discriminates whether the approval has been decided. If the result is not an approval nor a rejection, a step S4208 proceeds to a next object of process whereupon the process returns to the step S4202 to repeat the process.

In case the step S4204 identifies that the result is a rejection, a step S4205 informs the requester at the request source of a purchase rejection event, then a step S4207 deletes the approval request of the object of process from the purchase approval request registration information and a step S4208 advances the object of process to a next approval request, whereupon the sequence returns to the step S4202.

In case the step S4204 identifies that the approval is decided, a step S4206 informs the requester at the request source of a purchase approval event, then a step S4207 deletes the approval request of the object of process from the purchase approval request registration information and a step S4208 advances the object of process to a next approval request, whereupon the sequence returns to the step S4202.

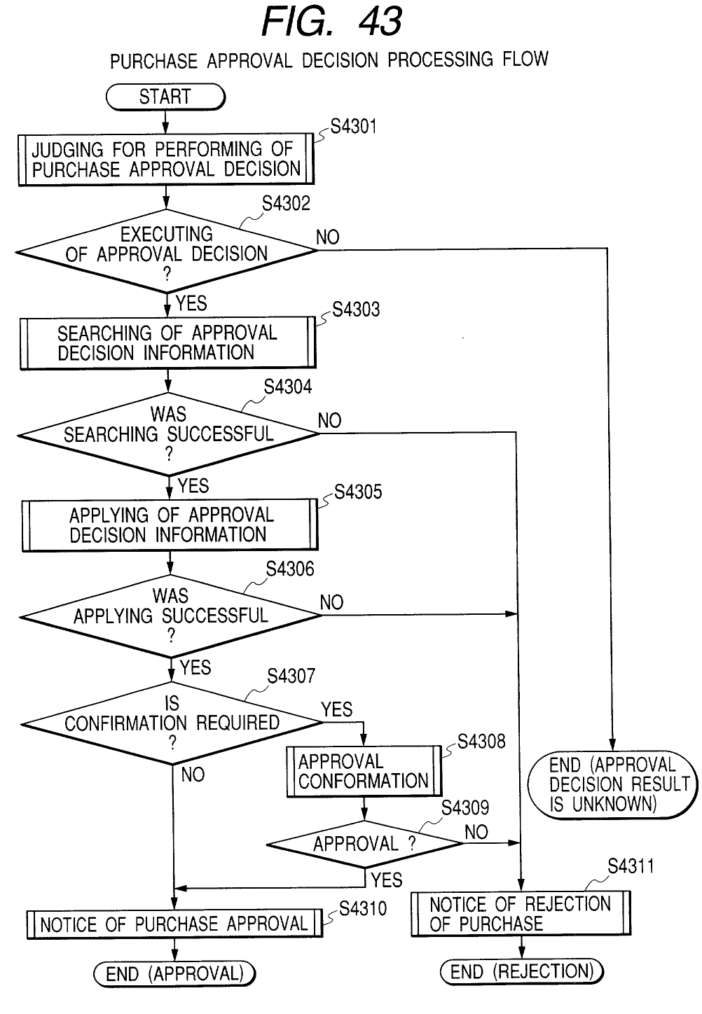

FIG. 43 is a flow chart of the purchase approval decision process of the step S4203 in FIG. 42.

In the purchase approval decision process of the present information processing apparatus, the decision whether or not to approve the purchase approval request by searching and applying the approval decision information only in case the approval decision is judged necessary. More specifically, when the purchase approval decision process is activated, a step S4301 executes a purchase approval decision judging process for searching and acquiring the approval service corresponding to the approval request of the object of process from the service server, and judging whether or not to perform the approval decision according to whether the approval service has been acquired. As a result, if a next step S4302 doe not identify that the approval decision is to be performed, the result of the approval decision is regarded as unclear and the process is terminated.

On the other hand, if the step S4302 identifies that the approval decision is to be performed, a next step S4303 performs the approval decision information searching process of searching the approval decision information corresponding to the purchase approval request of the object of process. As a result, if a next step S4303 does not identify that the search is successful, the sequence proceeds to a step S4311 for performing a purchase rejection informing process of informing the client terminal of the rejection of the purchase approval request whereby the result is regarded as a rejection and the process is terminated.

If the step S4304 identifies that the search is successful, a next step S4305 performs an approval decision information applying process for applying the purchase approval request to the aforementioned approval decision information. If a next step S4306 does not identify that the application is successful, the sequence proceeds to a step S4311 for performing a purchase rejection informing process of informing the client terminal of the rejection of the purchase approval request whereby the result is regarded as a rejection and the process is terminated.

If the step S4306 identifies that the application is successful, a next step S4307 discriminates whether the confirmation by the approval decider is necessary. If necessary, a step S4308 performs an approval confirming process for confirming the approval. As the result of such confirmation, if a next step S4309 does not identify an approval, the sequence proceeds to a step S4311 for performing a purchase rejection informing process of informing the client terminal of the rejection of the purchase approval request whereupon the result is regarded as a rejection and the process is terminated.

In case the step S4307 identifies that the confirmation by the approval decider is unnecessary or the step S4309 identifies an approval by the confirmation of the approval decider, a step S4310 performs a purchase approval informing process of informing that the purchase approval request is approved to the client terminal, whereupon the request is regarded as approved and the process is terminated.

In the following there will be explained, with reference to the foregoing drawings, a case of preparing a purchase approval request of the user, judging the purchase approval and performing the purchase in an environment utilizing the request server.

As already shown in FIG. 37, when the start of the purchase approval request is instructed in the client terminal, the step S3805 shown in FIG. 38 performs the purchase approval request preparing process to prepare a purchase approval request.

For example, when the operating user “Taro” enters, in the operating device “compo”, a name “Small Signs of Autumn (for three reproductions)”, a classification “music”, a monetary amount “Y80”, a delivery date “Dec. 15, 1999” and a priority “80” and selects the purchase approval request button 127 as shown in FIG. 12, there is prepared a purchase approval request as shown in FIG. 13.

As a result, the next step S3806 identifies that the preparation of the purchase approval request is successful and the succeeding step S3807 executes the purchase approval request registration process to register the “purchase approval request ‘Small Signs of Autumn’” as represented by 3702 in FIG. 37 in the request server 3701.

In response, the purchase approval request server 3701 judges that the registration of the purchase approval request is instructed from the client terminal, and registers the purchase approval request in the purchase approval request registration information as shown in FIGS. 40 and 41 (S3906). Thereafter the purchase approval collective decision process of a step S3902 decide whether or not to approve the purchase approval requests stored in the purchase approval request registration information.

More specifically, the purchase approval deciding process of a step 4203 decides whether or not to approve each purchase approval request.

In this operation, the purchase approval decision judging process of a step S4301 in the purchase approval decision process shown in FIG. 43 searches the purchase approval service corresponding to the aforementioned purchase approval request from the purchase approval service registration information held by the service server shown in FIG. 23.

In case of the purchase approval request shown in FIG. 13, a method is provided by the “music approval service” searched corresponding to the classification “music”. The approval decision information searching process of a step S4303, by referring to the budget information in FIG. 19, searches the requesting device “compo”. As a result, a next step S4304 identifies that the search is successful and a next step S4305 executes the approval decision information applying process to apply the requested amount Y80 to the budget Y0 of the requester “Taro”, but the application fails because of the shortage of the budget. Thus a step S4311 informs that the purchase is rejected and the process is terminated.

On the other hand, in case of a purchase approval request as shown in FIG. 14, a method is provided by the “Music Flash approval service” searched corresponding to the classification “Music Flash”. The approval decision information searching process of the step S4303, by referring to the budget information in FIG. 19, searches the requesting device “compo”, and the approval decision information applying process of the step S4305 tries to apply the requested amount ¥80 to the budget ¥2,000 of the requester “Taro”. The attempt is successful since the requested amount can be accommodated in the budget. Then a step S4307 discriminates the necessity of approval confirmation, and identifies that the approval confirmation is unnecessary because it is not designated as “necessary”. Thus a step S4310 informs that the purchase is approved and the process is terminated.

As explained in the foregoing, the present embodiment utilizes a request server storing plural approval request, thereby dispersing the approval request preparing process and the approval request deciding process in different devices and thus achieving more flexible operation. Thus each client terminal need not execute the approval deciding process for each approval request generated.

Also more flexible operations are enabled by utilizing the registering, deleting, renewing and searching functions in the request server. For example it is rendered possible to execute approval decision collectively for the purchase approval requests from plural client terminals.

It is also possible to perform the approval decision at every predetermined time or date, and to alter or cancel the request if the approval deciding process is not yet performed.

There may also be constructed a configuration in which the purchase approval request is stored without the approval deciding process while the approval decider is absent and the approval deciding process is executed when the approval decider returns.

(Embodiment 4)

The present embodiment 4 is rendered capable, in case the required approval service is not present in the service server at the initial search of the approval service but is added later to the service server, of executing the approval request deciding process utilizing such added approval service.

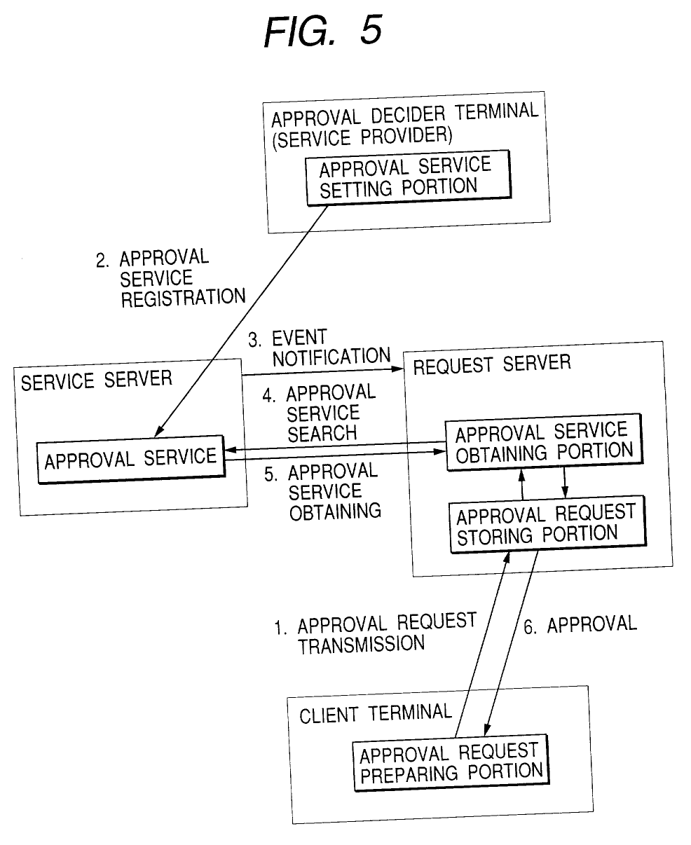

FIG. 5 shows the relationship among the client terminal to be used by the purchase approval requester, the approval decider terminal (service provider) to be used by the purchase approval decider, the service server for registering and managing the purchase approval service, and the request server for registering and managing the purchase approval request.

More specifically, the process is executed in the following flow.

1. The purchase approval request prepared in the client server is registered in the purchase approval request server. Then the request server searches the approval service, but it is assumed that the desired approval service is not found in the initial search and that such approval request is stored in the approval request storing portion.

2. The approval decider registers the purchase approval service in the purchase approval service server, utilizing the service provider.

3. In response to the registration of the purchase approval service, the purchase approval service server informs the purchase approval request server of a purchase approval service registration event.

4. Receiving the information of the approval service registration event, the purchase approval request server searches, in the purchase approval service server, the purchase approval service corresponding to each purchase approval request registered in the approval request storing portion.

5. In case the search for the approval service is successful, such approval service is acquired and there is performed the decision for the approval request.

6. The result of decision for the approval request utilizing thus acquired purchase approval service is informed to the client terminal of source of the purchase approval request.

In the foregoing description, it has been explained that the purchase approval request server performs the process by acquiring the purchase approval service itself from the purchase approval service server, but it is also possible to acquire only information necessary for the process.

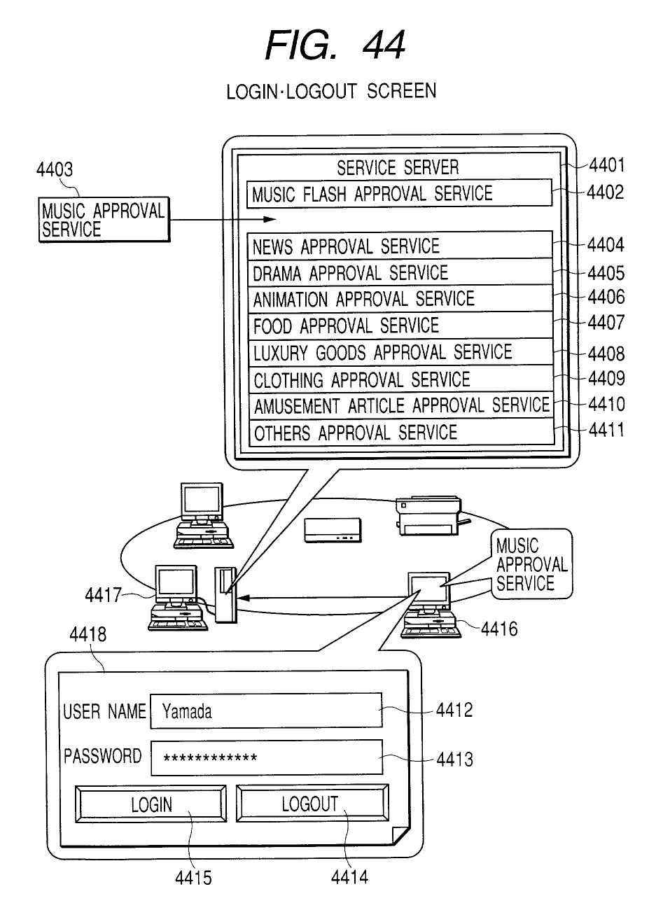

FIG. 44 shows, as an example of registration of the purchase approval service from the service provider, utilized by the approval decider, to the purchase approval service server as shown in FIG. 5, such registration in relation to a log-in/logout operation of the approval decider on the service provider system.

More specifically, when the approval decider operates a purchase approval service provider 4416, there is displayed a log-in image 4418. When the approval decider enters a user name 4412 and a password 4413 and depresses a log-in button 4415, there is executed a log-in operation on the purchase approval service provider 4416 and an approval service registration process is automatically activated, whereby a purchase approval service 4403 corresponding to the logged-in approval decider is registered in a purchase approval service server 4417. Also, when the approval decider depresses a log-out button 4414, an approval service deleting process of the purchase approval service provider 4416 is automatically activated whereby the purchase approval service 4403 corresponding to the approval decider is deleted from the purchase approval service server 4417.

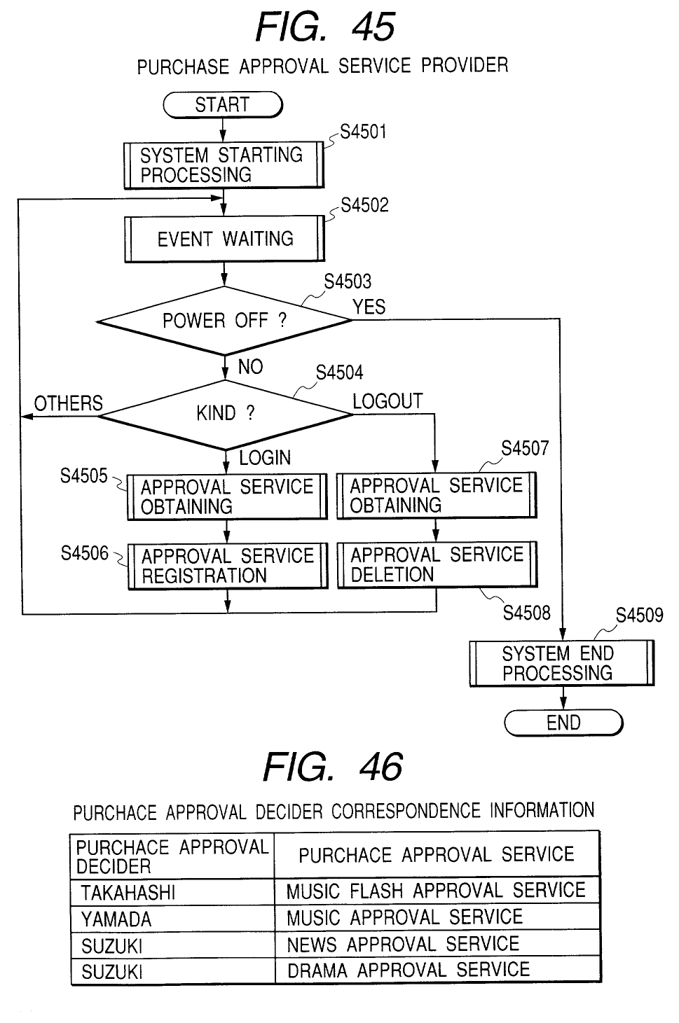

FIG. 45 shows the process in the purchase approval service provider 4416 for controlling the start and end of the purchase approval service, in relation to the log-in/log-out operation of the approval decider. More specifically, when the purchase approval service provider 4416 is activated, a step S4501 executes an initializing process for initializing various devices and memories of the system. Then a step S4502 awaits generation of various events such as an input operation from the user, a reception of information from other devices, or a signal from a timer.

When any event is generated, a next step S4503 discriminates whether the event instructs turning-off of the power supply, and, if so, a system ending process of a step S4509 executes ending processes for the devices and memories in the system whereby the operation of the system is terminated.

In case the step S4503 identifies that the event does not instruct the turning-off of the power supply, a next step S4504 discriminates whether the event is an instruction for login/log-out. If not, the sequence returns to the step S4502.

If the step S4504 identifies that the event instructs the log-in, a step S4505 performs an approval service acquiring process to refer to the approval decider correspondence information to be explained later, thereby acquiring all the purchase approval service information corresponding to the logged-in approval decider. A succeeding step S4506 performs an approval service registration process to register the acquired approval service in the service server 4417 (cf. FIG. 44) whereupon the sequence returns to the step S4502.

If the step S4504 identifies that the event instructs a log-out, a step S4507 performs an approval service acquiring process refer to the approval decider correspondence information to be explained later, thereby acquiring all the purchase approval service information corresponding to the logged-out approval decider. A succeeding step S4508 performs an approval service deleting process to delete the approval service corresponding to the acquired approval service information from the service server 4417 whereupon the sequence returns to the step S4502.

FIG. 46 shows an example of the purchase decider correspondence information to be referred to in the approval service acquiring process in the steps S4505 and S4507.

In the approval decider correspondence information in the present information processing apparatus, there are defined an approval decider and a purchase approval service corresponding to each approval decider. For example, a purchase approval service “Music Flash approval service” is made to correspond to an approval decider “Takahashi”, and purchase approval services “news approval service” and “drama approval service” are made to correspond to an approval decider “Suzuki”.

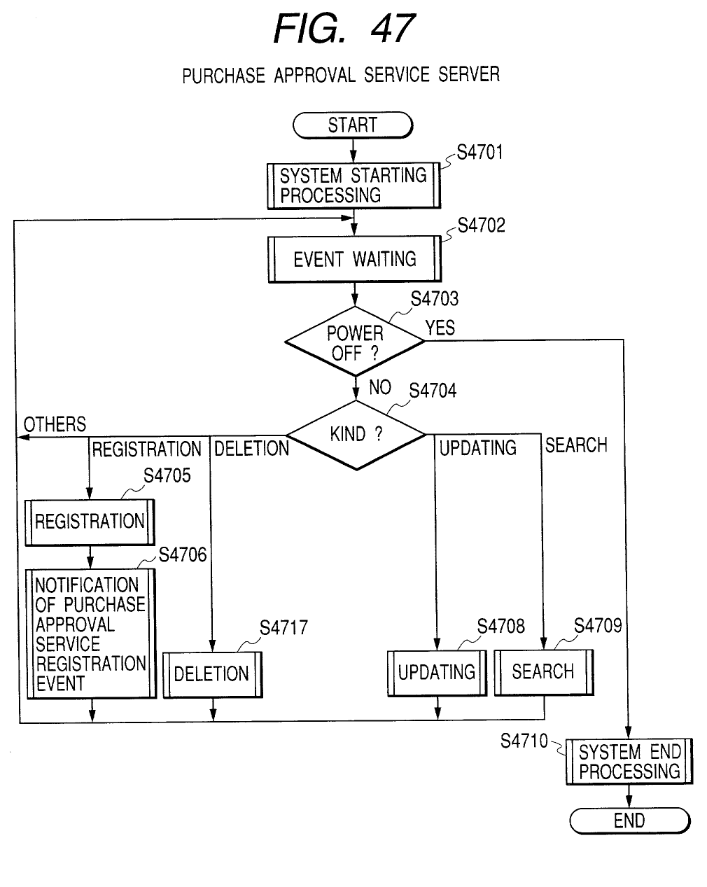

FIG. 47 shows a process in the purchase approval service server 4417 (cf. FIG. 44) capable of informing the purchase approval request server of the purchase approval service registration event. More specifically, when the purchase approval service server is activated, a step S4701 executes a system initializing process for initializing various devices and memories of the system. Then a step S4702 awaits generation of various events such as an input operation from the user, a reception of information from other devices, or a signal from a timer.

When any event is generated, a next step S4703 discriminates whether the event instructs turning-off of the power supply, and, if so, a system ending process of a step S4710 executes ending processes for the devices and memories in the system whereby the operation of the system is terminated.

In case the step S4703 identifies that the event does not instruct the turning-off of the power supply, a next step S4704 discriminates the type of the event. As a result, if it is not identified as an instruction for the approval service, the sequence returns to the step S4702.

If the step S4704 identifies that the event instructs the registration of an approval service, a step S4705 performs an approval service registration process to register the approval service, transmitted from the service provider, in the approval service registration information, then a next step S4706 informs the purchase approval request server of a purchase approval service registering event, whereupon the sequence returns to the step S4702.

If the step S4704 identifies that the event instructs the deletion of an approval service, a step S4707 performs an approval service deletion process to delete the corresponding approval service from the approval service registration information, whereupon the sequence returns to the step S4702.

If the step S4704 identifies that the event instructs the renewal of an approval service, a step S4708 performs an approval service renewal process to renew the corresponding approval service, stored as the approval service registration information, whereupon the sequence returns to the step S4702.

If the step S4704 identifies that the event instructs the search of an approval service, a step S4709 performs an approval service search process to search the corresponding approval service from the approval service registration information and to transfer it to the search requesting source, whereupon the sequence returns to the step S4702.

In the following there will be explained a case where the purchase approval request is registered in the request server in the absence of the corresponding purchase approval service in the initial state but the corresponding purchase approval service is registered in the service server in response to the log-in operation of the approval decider as shown in FIGS. 5 and 44.

When the start of preparation of a purchase approval request is instructed in the client terminal as shown in FIG. 5, a step S3805 shown in FIG. 38 executes the purchase approval request preparing process to prepare the purchase approval request.

For example, when the operating user “Taro” enters, in the operating device “compo”, a name “Small Signs of Autumn (for three reproductions)”, a classification “music”, a monetary amount “¥80”, a delivery date “Dec. 15, 1999” and a priority “80” and selects the purchase approval request button 127 as shown in FIG. 12, there is prepared a purchase approval request as shown in FIG. 13.

As a result, a next step S3806 identifies that the preparation of the purchase approval request is successful and a succeeding step S3807 executes the purchase approval request registration process to register “purchase request ‘Small Signs of Autumn’” in the request server.

In response, the purchase approval request server receives, in a step S3903, an event corresponding to the purchase approval request registration process of the client terminal, then identifies the event as instructing the registration in a step S3905 and registers the aforementioned purchase approval request in the purchase approval request registration information as shown in FIGS. 40 and 41. Thereafter a step S3905 performs the purchase approval collective deciding process to decide whether or not to approve the purchase approval requests stored in the purchase approval request registration information. More specifically, the purchase approval deciding process of a step S4203 decides whether or not to approve each purchase approval request.

In case of the aforementioned purchase approval request, the purchase approval decision judging process of a step S4301 in the purchase approval deciding process searches the purchase approval service, corresponding to the aforementioned purchase approval request, in the purchase approval service registration information held in the service server. However, as the purchase approval service corresponding to the classification “music” of the aforementioned purchase approval request cannot be found, a step S4204 skips the process, withholding the approval decision.

Thereafter, when the approval decider “Yamada” logs in the system from the purchase approval service provider as shown in FIGS. 5 and 44, a step S4504 in FIG. 45 identifies the instruction for log-in and a next step S4505 executes a purchase approval service acquiring process to acquire the “music approval service” by referring to the approval decider correspondence information. Then a step S4506 executes a purchase approval service registration process to register the “music approval service”, as indicated by 4403 in FIG. 44, in the purchase approval service server 4417.

Thus, in the purchase approval service server, a step S4704 identifies the instruction for registration of the purchase approval service, then a step S4705 registers the approval service transmitted from the service provider, and a step S4706 informs the purchase approval request server of a purchase approval service registration event.

In the purchase approval request server, having received the aforementioned purchase approval service registration event, there is again executed the purchase approval collective deciding process of the step S3902 to decide whether or not to approve the purchase approval requests stored in the purchase approval request registration information. At first an approval service search process searches the purchase approval service corresponding to the classification “music” of the aforementioned purchase approval request thereby acquiring the “music approval service” searched corresponding to the classification “music”. Then a step S4303 executes an approval decision information search process to refer to the budget information constituting the deciding condition for the music approval service as shown in FIG. 28, thereby searching the request device “compo”.

As a result, a next step S4304 identifies that the search is successful, and a next step S4305 executes an approval decision information applying process to apply the requested amount ¥80 to the budget ¥0 of the classification “music”, requester “Taro” and requesting device “compo” but the application fails because of the shortage of the budget. Thus a step S4311 informs that the purchase is rejected.

On the other hand, in case of a purchase approval request as shown in FIG. 14, there is acquired “Music Flash approval service” searched corresponding to the classification “Music Flash”. Then an approval decision information search process in a step S4303 tries to apply the requested amount ¥80 to the budget ¥2,000 of the requesting device “compo” and requester “Taro” by referring to the budget information shown in FIG. 27. The attempt is successful since the requested amount can be accommodated in the budget. Then the step S4307 discriminates the necessity of approval confirmation, and identifies that the approval confirmation is unnecessary because it is not designated as “necessary”. Thus the step S4310 informs that the purchase is approved and the process is terminated.

In the present embodiment, as explained in the foregoing, even if the approval decision cannot be performed by the absence of the corresponding purchase approval service at the registration of the purchase approval request in the purchase approval request server, but the approval decision is rendered possible corresponding to the subsequent registration of the purchase approval service in the purchase approval service server.

Therefore the approval requester can submit the approval request without waiting for the registration of the approval service.

For example the purchase approval requests of plural approval requesters may be collectively approved by the approval decider. There may also be constructed a configuration in which the purchase approval request is stored without the approval deciding process while the approval decider is absent and the approval deciding process is executed when the approval decider returns and executes the log-in operation.

(Embodiment 5)

In the foregoing embodiment 4, there has been explained a configuration in which the purchase approval request purchase approval service is registered or deleted in relation to the log-in or log-out operation of the approval decider, but the present embodiment 5 explains a system utilizing a purchase approval card including the purchase approval service.

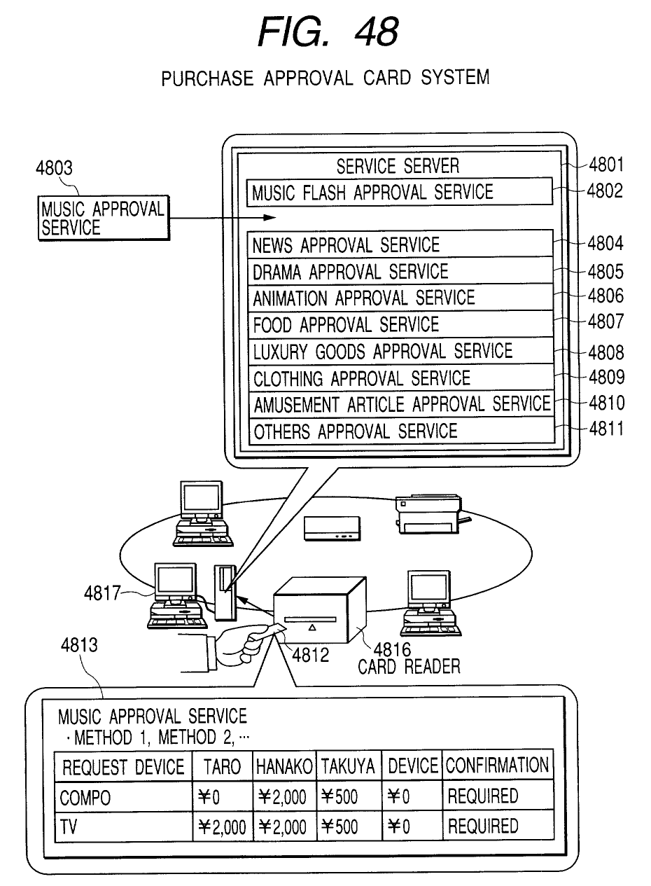

FIG. 48 shows a configuration in which the registration or deletion of the purchase approval service by the approval decider to or from the purchase approval service server in linkage with an inserting or extracting operation of a purchase approval card including the purchase approval service.

More specifically, when the approval decider inserts a purchase approval card 4812 into a purchase approval service provider 4816, the approval service registering service thereof registers the corresponding purchase approval service 4813 in the purchase approval service server 4817. Also when the approval decider extracts the purchase approval card 4812 from the purchase approval service provider 4816, the approval service deleting process thereof deletes the corresponding purchase approval service 4813 from the purchase approval service server 4817.

In the foregoing, there has been explained as if the purchase approval card 4812 stores only one purchase approval service, but it is also possible to store plural purchase approval services and to register or delete the plural purchase approval services by the insertion or extraction of the purchase approval card 4812.

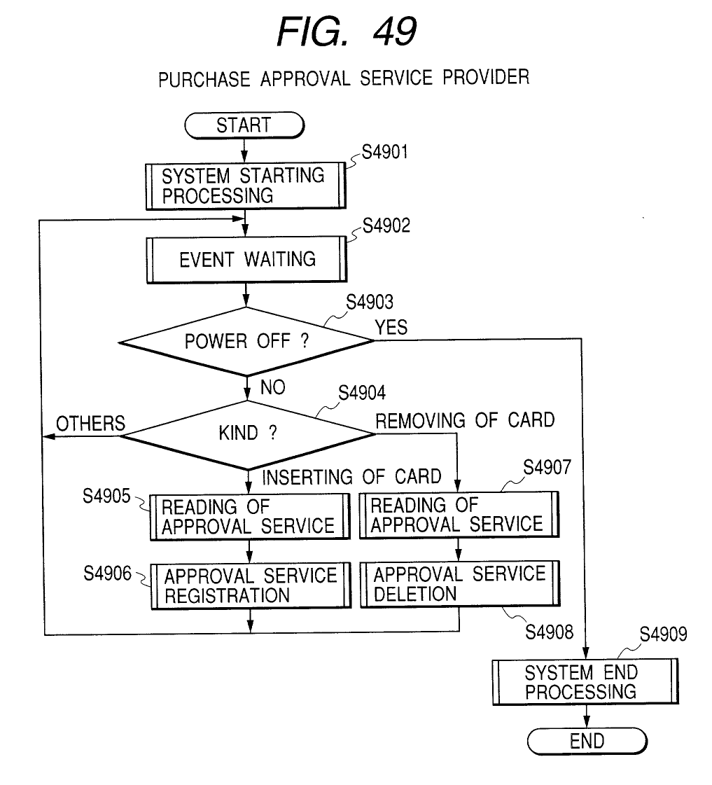

FIG. 49 shows the process in the purchase approval service provider.

More specifically, when the purchase approval service provider is activated, a step S4901 executes an initializing process for initializing various devices and memories of the system. Then a step S4902 awaits generation of various events such as an input operation from the user, a reception of information from other devices, or a signal from a timer.

When any event is generated, a next step S4903 discriminates whether the event instructs turning-off of the power supply, and, if so, a system ending process of a step S4909 executes ending processes for the devices and memories in the system whereby the operation of the system is terminated.

In case the step S4903 identifies that the event does not instruct the turning-off of the power supply, a next step S4904 discriminates whether the event instructs an inserting or extracting operation of the purchase approval card, and, if not, the sequence returns to the step S4902.

If the step S4904 identifies that the event instructs the inserting operation of the purchase approval card, a step S4905 performs an approval service reading process to read the approval service stored in the purchase approval card, and a next step S4906 executes an approval service registering process for registering the read approval service in the service server 4817, whereupon the sequence returns to the step S4902.

If the step S4904 identifies an extracting operation of the purchase approval card, a step S4907 performs an approval service reading process to read the approval service stored in the purchase approval card, and a next step S4908 executes an approval service deleting process for deleting the corresponding approval service from the service server 4817, whereupon the sequence returns to the step S4902.

In the following there will be explained a case where the purchase approval request is registered in the request server in the absence of the corresponding purchase approval service in the initial state but the corresponding purchase approval service is registered in the service server in response to the later insertion of the purchase approval card as shown in FIGS. 5 and 44.

When the start of preparation of a purchase approval request is instructed in the client terminal as shown in FIG. 5, a step S3805 shown in FIG. 38 executes the purchase approval request preparing process to prepare the purchase approval request.

For example, when the operating user “Taro” enters, in the operating device “compo”, a name “Small Signs of Autumn (for three reproductions)”, a classification “music”, a monetary amount “¥80”, a delivery date “Dec. 15, 1999” and a priority “80” and selects the purchase approval request button 127 as shown in FIG. 12, there is prepared a purchase approval request as shown in FIG. 13.

As a result, a next step S3806 identifies that the preparation of the purchase approval request is successful and a succeeding step S3807 executes the purchase approval request registration process to register “purchase request ‘Small Signs of Autumn’” in the request server.

In response, the purchase approval request server receives, in a step S3903, an event corresponding to the purchase approval request registration process of the client terminal, then identifies the event as instructing the registration in a step S3905 and registers the aforementioned purchase approval request in the purchase approval request registration information as shown in FIGS. 40 and 41. Thereafter a step S3902 performs the purchase approval collective deciding process to decide whether or not to approve the purchase approval requests stored in the purchase approval request registration information. More specifically, the purchase approval deciding process of a step S4203 decides whether or not to approve each purchase approval request.

In case of the aforementioned purchase approval request, the purchase approval decision judging process of a step S4301 in the purchase approval deciding process searches the purchase approval service, corresponding to the aforementioned purchase approval request, in the purchase approval service registration information held in the service server. However, as the purchase approval service corresponding to the classification “music” of the aforementioned purchase approval request cannot be found, a step S4204 skips the process, withholding the approval decision.

Thereafter, when the purchase approval card 4812 is inserted in the purchase approval service provider 4816 as shown in FIGS. 5 and 44, a step S4904 in FIG. 49 identifies the insertion of the purchase approval card and a next step S4905 executes a purchase approval service reading process to read the approval service stored in the purchase approval card. Then a step S4906 executes a purchase approval service registration process to register the “music approval service”, as indicated by 4803 in FIG. 48, in the purchase approval service server 4417.

Thus, in the purchase approval service server, a step S4704 identifies the instruction for registration of the purchase approval service, then a step S4705 registers the approval service transmitted from the service provider, and a step S4706 informs the purchase approval request server of a purchase approval service registration event.

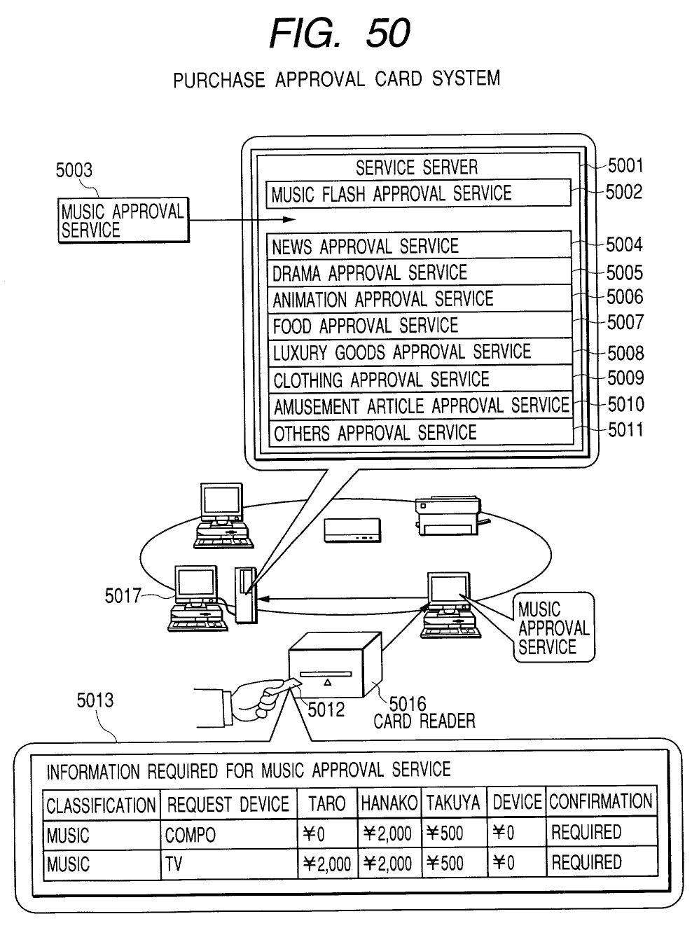

In the purchase approval request server, having received the aforementioned purchase approval service registration event, there is again executed the purchase approval collective deciding process of the step S3902 to decide whether or not to approve the purchase approval requests stored in the purchase approval request registration information. At first an approval service search process searches the purchase approval service corresponding to the classification “music” of the aforementioned purchase approval request thereby acquiring the “music approval service” searched corresponding to the classification “music”. Then a step S4303 executes an approval decision information search process to refer to the budget information 5013 shown in FIG. 50 and constituting the deciding condition for the music approval service as shown in FIG. 28, thereby searching the request device “compo”.

As a result, a next step S4304 identifies that the search is successful, and a next step S4305 executes an approval decision information applying process to apply the requested amount ¥80 to the budget Y0 of the classification “music”, requester “Taro” and requesting device “compo” but the application fails because of the shortage of the budget. Thus a step S4311 informs that the purchase is rejected.

On the other hand, in case of a purchase approval request as shown in FIG. 14, there is acquired “Music Flash approval service” searched corresponding to the classification “Music Flash”. Then an approval decision information search process in a step S4303 tries to apply the requested amount ¥80 to the budget ¥2,000 of the requesting device “compo” and requester “Taro” by referring to the budget information shown in FIG. 27. The attempt is successful since the requested amount can be accommodated in the budget. Then the step S4307 discriminates the necessity of approval confirmation, and identifies that the approval confirmation is unnecessary because it is not designated as “necessary”. Thus the step S4310 informs that the purchase is approved and the process is terminated.

In the present embodiment 5, as explained in the foregoing, even if the approval decision cannot be performed by the absence of the corresponding purchase approval service at the registration of the purchase approval request in the purchase approval request server, but the approval decision is rendered possible utilizing the purchase approval service added to the service server in connection with the insertion of the purchase approval card. In this manner, the registration and deletion of the purchase approval service can be easily controlled by the purchase approval card.

(Embodiment 6)

In the foregoing embodiment 5, the purchase approval card stores method of the purchase approval service and condition data thereof to be use for decision, but, in the present embodiment 6, the purchase approval card only stores the condition data of the purchase approval service.

FIG. 50 shows a configuration in which the registration or deletion of the purchase approval service by the approval decider to or from the purchase approval service server in linkage with an inserting or extracting operation of a purchase approval card including the purchase approval service. More specifically, when the approval decider inserts a purchase approval card 5012 into a purchase approval service provider 5016, the approval service registering service thereof prepares a purchase approval service from information 5013 stored in the purchase approval card 5012 and required for the purchase approval service and registers it in a purchase approval service server 5017. Also when the approval decider extracts the purchase approval card 5012, the approval service deleting process of the purchase approval service provider 5016 deletes the corresponding purchase approval service from the purchase approval service server 5017.

In the foregoing, there has been explained as if the purchase approval card 5012 stores information necessary for only one purchase approval service, but it is also possible to store information necessary for plural purchase approval services and to prepare, register or delete the plural purchase approval services by the insertion or extraction of the purchase approval card 5012.

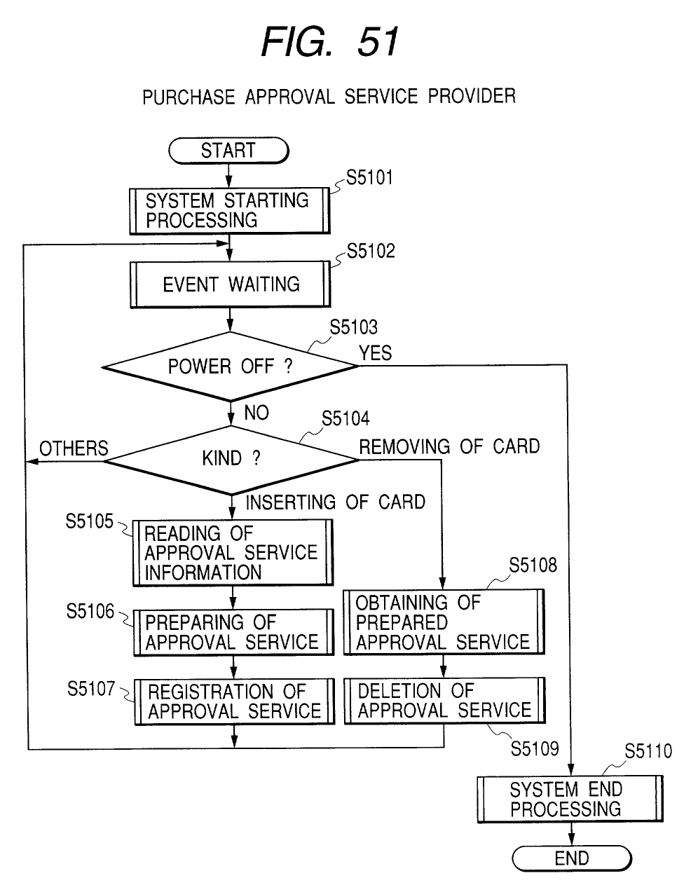

FIG. 51 shows the process in the purchase approval service provider 5016. More specifically, when the purchase approval service provider is activated, a step S5101 executes an initializing process for initializing various devices and memories of the system. Then a step S5102 awaits generation of various events such as an input operation from the user, a reception of information from other devices, or a signal from a timer.

When any event is generated, a next step S5103 discriminates whether the event instructs turning-off of the power supply, and, if so, a system ending process of a step S5110 executes ending processes for the devices and memories in the system whereby the operation of the system is terminated.

In case the step S5103 identifies that the event does not instruct the turning-off of the power supply, a next step S5104 discriminates whether the event instructs an inserting or extracting operation of the purchase approval card, and, if not, the sequence returns to the step S5102.

If the step S5104 identifies that the event instructs the inserting operation of the purchase approval card, a step S5105 performs an approval service information reading process to read the information necessary for the approval service stored in the purchase approval card, and a next step S5106 performs an approval service preparing process for preparing a purchase approval service object having information necessary for the aforementioned purchase approval service and storing it as prepared purchase approval service information to be explained later. Then a next step S5107 executes an approval service registering process for registering the prepared approval service in the service server 5017, whereupon the sequence returns to the step S5102.

If the step S5104 identifies an extracting operation of the purchase approval card, a step S5108 performs a prepared approval service acquiring process to acquire the prepared purchase approval service by referring to the prepared purchase approval service information to be explained later. Then a next step S5109 executes an approval service deleting process for deleting the acquired approval service from the service server 4817, whereupon the sequence returns to the step S5102.

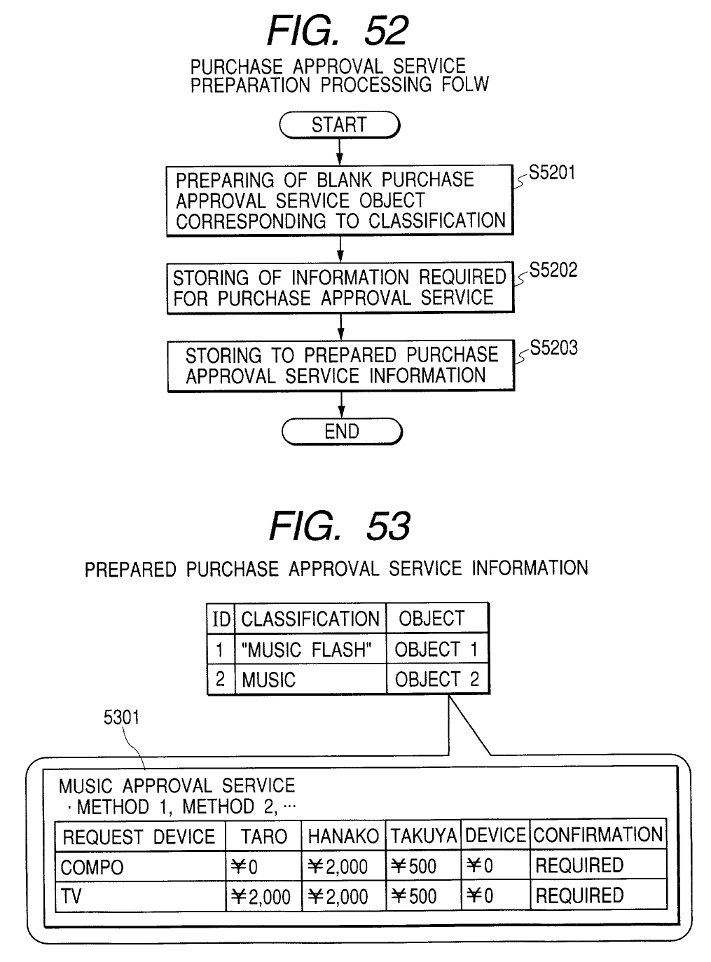

FIG. 52 shows the purchase approval service preparing process of the step S5106 shown in FIG. 51.

The purchase approval service preparing process prepares a purchase approval service object having information necessary for the purchase approval service, and stores it as prepared purchase approval service information to be explained later.

More specifically, when the purchase approval service preparing process is activated, a step S5201 prepares an empty purchase approval service object having a method corresponding to the classification stored in the read information necessary for the purchase approval service.

A step S5202 stores the information, read from the purchase approval card and necessary for the purchase approval service, in the aforementioned purchase approval request purchase approval request purchase approval service object.

A next step S5203 stores the aforementioned prepared purchase approval service object in the prepared purchase approval service information to be explained later, whereupon the process is terminated.

FIG. 53 shows an example of the prepared purchase approval service information storing the purchase approval service object prepared in the step S5203 in FIG. 52.

The prepared purchase approval service information of the present information processing apparatus stores an ID, a classification thereof and a corresponding purchase approval service object in mutual correspondence.

In the following there will be explained a case where the purchase approval request is registered in the request server in the absence of the corresponding purchase approval service in the initial state but the corresponding purchase approval service is registered in the service server in response to the later insertion of the purchase approval card as shown in FIGS. 5 and 50.

When the start of preparation of a purchase approval request is instructed in the client terminal as shown in FIG. 5, the step S3805 shown in FIG. 38 executes the purchase approval request preparing process to prepare the purchase approval request. For example, when the operating user “Taro” enters, in the operating device “compo”, a name “Small Signs of Autumn (for three reproductions)”, a classification “music”, a monetary amount “¥80”, a delivery date “Dec. 15, 1999” and a priority “80” and selects the purchase approval request button 127 as shown in FIG. 12, there is prepared a purchase approval request as shown in FIG. 13.

As a result, the next step S3806 identifies that the preparation of the purchase approval request is successful and a succeeding step S3807 executes the purchase approval request registration process to register “purchase request ‘Small Signs of Autumn’” in the request server.

In response, the purchase approval request server receives, in the step S3903, an event corresponding to the purchase approval request registration process of the client terminal, then identifies the event as instructing the registration in a step S3905 and registers the aforementioned purchase approval request in the purchase approval request registration information as shown in FIGS. 40 and 41. Thereafter the step S3902 performs the purchase approval collective deciding process to decide whether or not to approve the purchase approval requests stored in the purchase approval request registration information. More specifically, the purchase approval deciding process of the step S4203 decides whether or not to approve each purchase approval request.

In case of the aforementioned purchase approval request, the purchase approval decision judging process of the step S4301 in the purchase approval deciding process searches the purchase approval service, corresponding to the aforementioned purchase approval request, in the purchase approval service registration information held in the service server. However, as the purchase approval service corresponding to the classification “music” of the aforementioned purchase approval request cannot be found, a step S4204 skips the process, withholding the approval decision.

Thereafter, when the purchase approval card 5012 is inserted in the purchase approval service provider 5016 as shown in FIGS. 5 and 50, a step S5104 in FIG. 51 identifies the insertion of the purchase approval card then a next step S5105 executes a purchase approval service information reading process to read the information necessary for the approval service stored in the purchase approval card and a next step S5106 executes an approval service preparing process for preparing a corresponding purchase approval service. Then a step S5107 executes a purchase approval service registration process to register the “music approval service”, as indicated by 5003 in FIG. 50, in the purchase approval service server 5017.

Thus, in the purchase approval service server, the step S4704 identifies the instruction for registration of the purchase approval service, then the step S4705 registers the approval service transmitted from the service provider, and the step S4706 informs the purchase approval request server of a purchase approval service registration event.

In the purchase approval request server, having received the aforementioned purchase approval service registration event, there is again executed the purchase approval collective deciding process of the step S3902 to decide whether or not to approve the purchase approval requests stored in the purchase approval request registration information. At first an approval service search process searches the purchase approval service corresponding to the classification “music” of the aforementioned purchase approval request thereby acquiring the “music approval service” searched corresponding to the classification “music”. Then the step S4303 executes an approval decision information search process to refer to the budget information 5013 shown in FIG. 50 and constituting the deciding condition for the music approval service as shown in FIG. 28, thereby searching the request device “compo”.

As a result, the next step S4304 identifies that the search is successful, and the next step S4305 executes an approval decision information applying process to apply the requested amount ¥80 to the budget ¥0 of the classification “music”, requester “Taro” and requesting device “compo” but the application fails because of the shortage of the budget. Thus the step S4311 informs that the purchase is rejected.

On the other hand, in case of a purchase approval request as shown in FIG. 14, there is acquired “Music Flash approval service” searched corresponding to the classification “Music Flash”. Then an approval decision information search process in the step S4303 tries to apply the requested amount ¥80 to the budget ¥2,000 of the requesting device “compo” and requester “Taro” by referring to the budget information shown in FIG. 27. The attempt is successful since the requested amount can be accommodated in the budget. Then the step S4307 discriminates the necessity of approval confirmation, and identifies that the approval confirmation is unnecessary because it is not designated as “necessary”. Thus the step S4310 informs that the purchase is approved and the process is terminated.

In the present embodiment 6, as explained in the foregoing, even if the approval decision cannot be performed by the absence of the corresponding purchase approval service at the registration of the purchase approval request in the purchase approval request server, but the approval decision is rendered possible utilizing the purchase approval service prepared and added to the service server in connection with the insertion of the purchase approval card. Also the memory capacity of the purchase approval card can be made small since the card is only required to store the information (condition data) necessary for the purchase approval service.

(Embodiment 7)

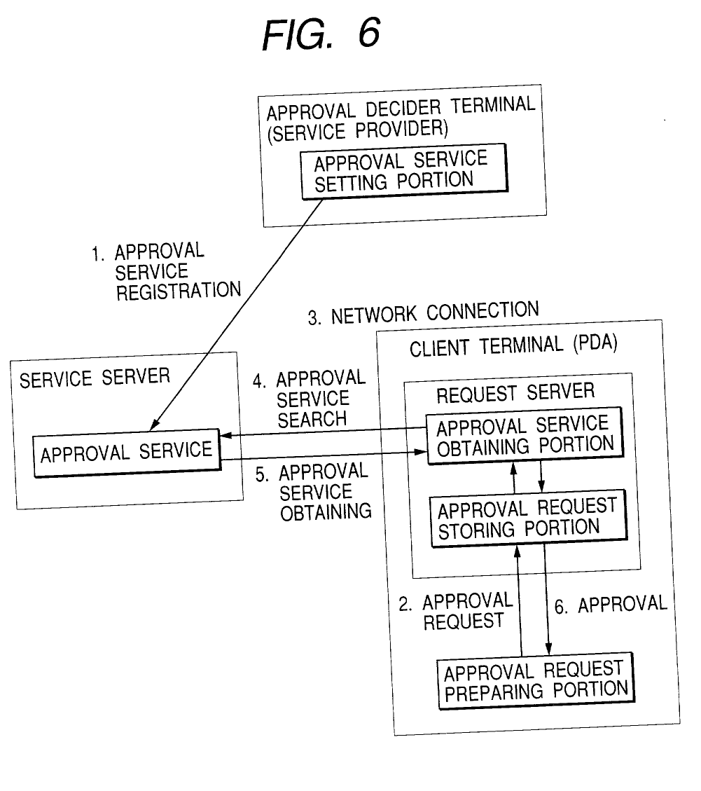

The present embodiment 7 employs a portable information terminal (PDA) as the client terminal as shown in FIG. 6 and provides such client terminal with a request server function for storing the approval request. Also, when the client terminal is connected to a network, the service server is searched to execute the decision process for the approval request.

The process of the present embodiment 7 is executed in the following manner.

1. The approval decider registers a purchase approval service in the purchase approval service server.

2. The purchase approval requester registers plural purchase approval requests in the purchase approval request server of a PDA (personal digital assistant) held by the approval requester. If the request server is not connected to a network capable of utilizing the approval service, the purchase approval request server cannot search the corresponding approval service, so that the approval request is stored until a network connection event is detected.

3. When the client terminal is connected to the network, a network connection event is informed to the request server.

4. The purchase approval request server detects the network connection event and searches, from the purchase approval service server, the purchase approval service corresponding to each purchase approval request registered in the purchase approval request purchase approval request approval request storing portion.

5. When the purchase approval service is searched, it is acquired and used for the decision process for the approval request.

6. There is informed the result of the decision process utilizing the acquired purchase approval service.

In the foregoing there has been explained a case where the purchase approval request server acquires the purchase approval service itself from the purchase approval service server for the process, but it is also possible to only acquire the information necessary for the process.

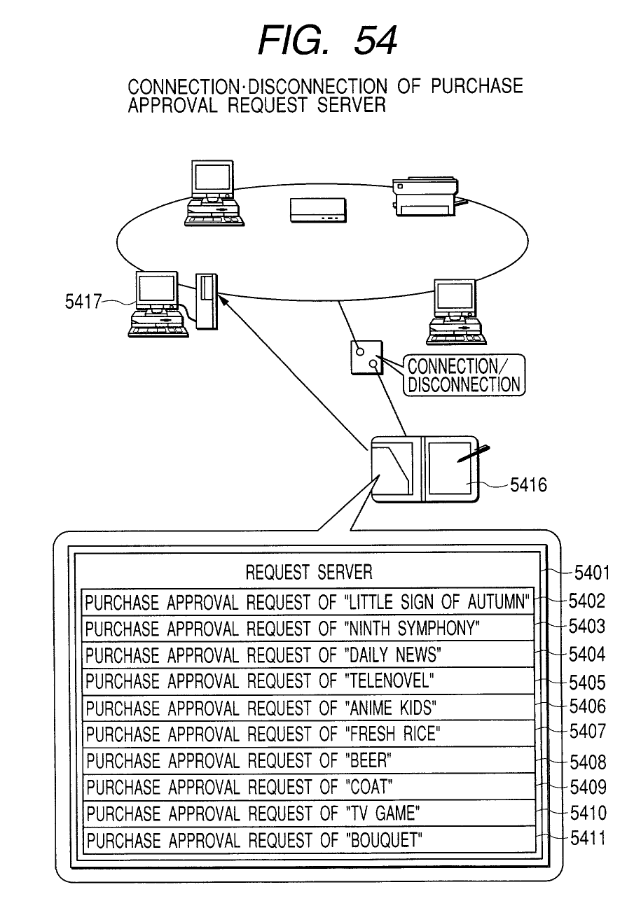

FIG. 54 shows, as an example of processing the purchase approval request, registered in the purchase approval request server 5401 in the PDA 5416 held by the approval requester as shown in FIG. 6, a mode of connection of the PDA 5416 to a network utilizable by the approval service.

More specifically, in case the purchase approval requester wishes a merchandise for example in the course of a window shopping, the requester adds a purchase approval request 5402 for such merchandise to the purchase approval request server 5401 in the PDA 5416. However, at the time of such addition, the PDA 5416 is not connected to the network and is not in an environment of acquiring the purchase approval service, so that such purchase approval request is stored. There are shown examples 5402 to 5411 of such stored purchase approval request.

Thereafter the purchase approval requester connects the PDA 5416 to the network to perform the process for the purchase approval request stored in the PDA.

The step S3903 in FIG. 39 detects a network connection event, and the purchase approval collective decision process of the step S3902 acquires the purchase approval services for the purchase approval requests 5402 to 5411 thereby performing the approval decision therefor.

In the present embodiment 7, as explained in the foregoing, the purchase approval request is once registered in the purchase approval request server in the PDA in a situation where the client terminal is incapable of utilizing the purchase approval service or in case it is not desired to utilize the purchase approval service, and the request server is connected to the environment capable of utilizing the purchase approval service at an arbitrary timing, thereby requesting collective approval decision and thus achieving more flexible operation.

(Embodiment 8)

The present embodiment 8 shows a case of utilizing a purchase approval request card storing the purchase approval request.

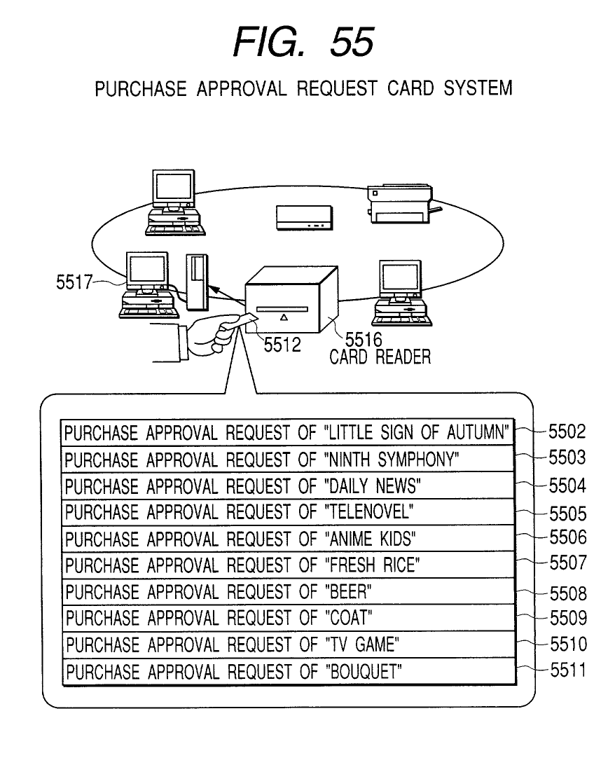

FIG. 55 shows a state, instead of connecting the PDA, held by the purchase approval requester directly to the network, of inserting a purchase approval request card 5512 storing the purchase approval requests 5502 to 5511 into a card reader 5516 connected to a network provided with the purchase approval request server.

More specifically, in case the purchase approval requester wishes a merchandise for example in the course of a window shopping, the requester gets a purchase approval request card placed in front of the merchandise. Otherwise, utilizing the PDA or a purchase approval request card writer provided in front of the merchandise, the requester adds a purchase approval request 5520 for such merchandise to the purchase approval request card of the requester.

Thereafter, when the purchase approval requester goes back to home, the requester inserts the purchase approval request card 5512 into the card reader 5516 connected to a home network whereby the process for the aforementioned purchase approval request is executed.

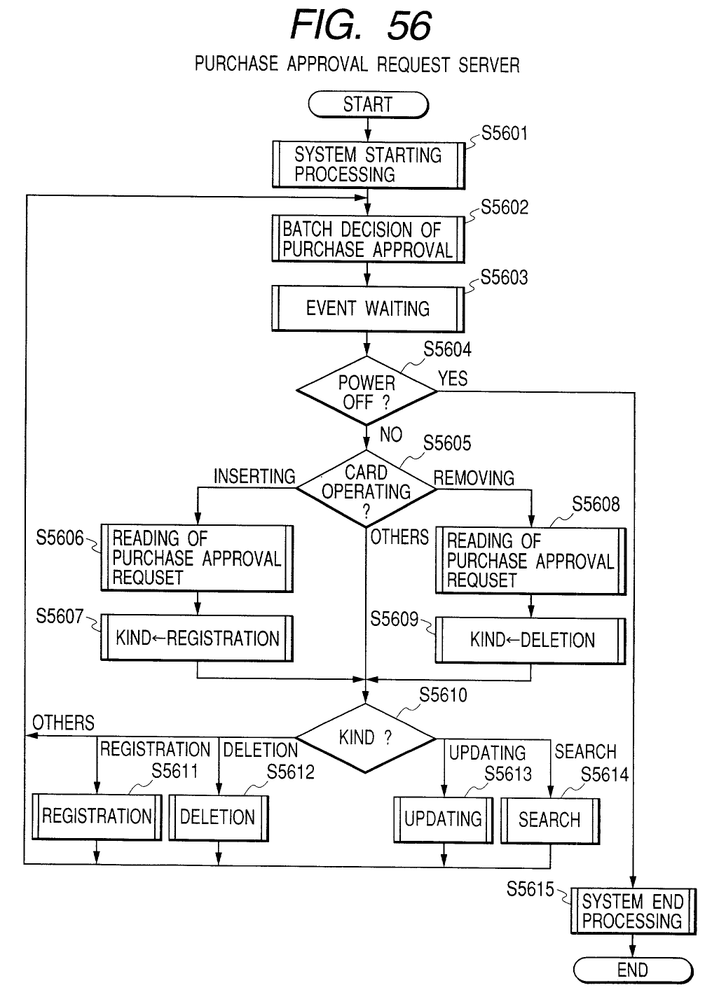

FIG. 56 is a view showing the process in the purchase approval request server of the card reader in the system of the present embodiment 8.

More specifically, when the purchase approval request server of the card reader is activated, a step S5601 executes a system initializing process for initializing various devices and memories of the system. Then a step S5602 executes a purchase approval collective decision process to perform approval decision on all the purchase approval requests stored in the purchase approval request registration information, and informs the result to the requester of the request source.

Then a next step S5603 awaits generation of various events such as an input operation from the user, a reception of information from other devices, or a signal from a timer. When any event is generated, a next step S5604 discriminates whether the event instructs turning-off of the power supply, and, if so, a system ending process of a step S5615 executes ending processes for the devices and memories in the system whereupon the operation of the system is terminated.

In case the step S5604 identifies that the event does not instruct the turning-off of the power supply, a next step S5605 discriminates whether the event instructs a card operation. As a result, if it is not identified as a card operation, the sequence proceeds to a step S5610.

If the step S5605 identifies that the event instructs an inserting operation of the purchase approval request card, a step S5606 performs an approval request reading process to read the purchase approval request stored in the purchase approval request card, and a next step S5607 changes the type of event to the instruction for registering the read purchase approval request.

If the step S5605 identifies that the event instructs an extracting operation of the purchase approval request card, a step S5608 performs a purchase approval request reading process to read the purchase approval request stored in the purchase approval request card, and a next step S5609 changes the type of event to the instruction for deleting the read purchase approval request.

A next step S5610 discriminates the type of the event. If it is not identified as an instruction for the purchase approval request, the sequence returns again to the step S5602.

If the step S5610 identifies that the event instructs the registration of the approval request, a step S5611 performs an approval request registration process to register the approval request, read from the card, in the approval request registration information, whereupon the sequence returns to the step S5602.

If the step S5610 identifies that the event instructs the deletion of the approval request, a step S5612 performs an approval request deletion process to delete the corresponding approval request from the approval request registration information, whereupon the sequence returns to the step S5602.

If the step S5610 identifies that the event instructs the renewal of the approval request, a step S5613 performs an approval request renewal process to renew the corresponding approval request stored in the approval request registration information, whereupon the sequence returns to the step S5602.

If the step S5610 identifies that the event instructs the search of the approval request, a step S5614 performs an approval request awexh process to search the corresponding approval request from the approval request registration information, whereupon the sequence returns to the step S5602.

As explained in the foregoing, the present embodiment 8 enables the approval decision process by merely inserting a card storing the purchase approval request into a card reader.

Also the registration in the purchase approval request card may be performed by a PDA or a card writer positioned in the vicinity of the merchandise, thereby realizing more flexible operation.

Also by obtaining the purchase approval request card itself, it is rendered possible to reduce the work of the purchase approval requester in registering the purchase approval request again in the purchase approval request card, thereby realizing more flexible operation.

(Other Embodiments)

The client server of the embodiment 2 (or the request server of the embodiments 3 to 8) searches the approval service stored in the service server and acquires the searched approval service, and the approval decision process is executed in the client server of the embodiment 2 (or the request server of the embodiments 3 to 8), but the approval decision process may be performed in the service server. More specifically, in case the client terminal of the embodiment 2 (or the request server of the embodiments 3 to 8) searches and finds the approval service, it is also possible to transmits such approval request to the service server for executing the approval decision process therein and to receive the result of the approval decision from the service server for showing such result to the approval requester.

Also the client terminal of the embodiment 2 (or request server of the embodiments 3 to 8) searches the approval service stored in the service server, but the search may also be executed in the service provider in addition to the service server. For example, the search may be executed directly in the service provider, or in the service provider in case the approval service matching the approval request cannot be found in the search of the service server.

The present invention may be applied to an apparatus consisting of a single equipment or a system consisting of plural equipment.

The present invention may naturally be attained also by supplying a system or an apparatus with a memory medium storing program codes of a software realizing the functions of the aforementioned embodiments and by reading and executing the program codes stored in the memory medium by a computer (or CPU or MPU) of such system or apparatus.

In such case, the program codes themselves read from the memory medium realize the novel functions of the present invention, and the memory medium storing the program codes constitute the present invention.

The memory medium storing the program codes can be, for example, a floppy disk, a hard disk, a manetooptical disk, an optical disk, a CD-ROM, a CD-R, a magnetic tape, a non-volatile memory card or a ROM.

The present invention includes not only a case where the computer execute the read program codes but also a case where an operating system or the like functioning on the computer executes all the processes or a part thereof under the instructions of the program codes thereby realizing the functions of the aforementioned embodiments.

The present invention further includes a case where the program codes read from the memory medium are stored in a memory provided in a function expansion board inserted in the computer or a function expansion unit connected thereto and a CPU or the like provided in such function expansion board or function expansion unit executes all the processes or a part thereof under the instructions of the program codes, thereby realizing the functions of the aforementioned embodiments.

Furthermore, the present invention is naturally applicable to a case where the program codes of a software realizing the functions of the aforementioned embodiments are delivered from a memory medium storing such program codes to the requester through a communication line such as a personal computer communication.

What is claimed is:

1. An information processing apparatus comprising:
approval request preparing means for preparing an approval request;
storage means for storing an approval service set by an approval service provider;
decision means for deciding whether or not to approve said prepared approval request, utilizing said stored approval service; and
output means for outputting the result of decision of said decision means.

2. An apparatus according to claim 1, further comprising:
execution means for executing a process corresponding to said approval request in case said outputted result of decision is an approval.

3. An apparatus according to claim 1, wherein said approval service includes a decision condition for decision according to the approval requester and the content of said approval request.

4. An apparatus according to claim 3, wherein said decision condition further includes information of an information processing apparatus preparing said approval request.

5. An apparatus according to claim 1, wherein said decision means discriminates a period prohibiting said decision and does not execute the approval decision for said approval request in case the current time is identified as within a prohibition period.

6. An approval system comprising a service server for managing plural approval services registered by an approval service provider and a client terminal having approval request preparing means for preparing an approval request;
wherein said client terminal further includes:
acquisition means for searching and acquiring an approval service matching said approval request, among the plural approval services registered in said service server;
decision performing means for performing the approval decision for said approval request, utilizing said acquired approval service; and
output means for outputting the result of decision of said decision performing means.

7. An approval system according to claim 6, wherein said service provider registers said approval service in said service server in response to the insertion of a card storing information of said approval service and deletes the corresponding approval service from said service server in response to the extraction of said card.

8. An approval system according to claim 6, wherein said client terminal further includes approval request storage means for storing plural approval request; and
said decision performing means executes the approval decision process for the plural approval requests stored in said approval request storage means.

9. An approval system according to claim 8, wherein said acquisition means is adapted, upon detecting that said client terminal is connected to said service server through a network, to search and acquire an approval service matching said approval request among the plural approval services stored in said service server.

10. An approval system according to claim 9, wherein said client terminal is a portable terminal.

11. An approval system according to claim 6, wherein said acquisition means is adapted, in response to the insertion of a card storing said approval request into said client terminal, to search and acquire an approval service matching said approval request among the plural approval services stored in said service server.

12. An approval system according to claim 6, wherein said client terminal further includes execution means for executing a process corresponding to said approval request in case said outputted decision result is an approval.

13. An approval system according to claim 6, wherein said approval service includes a decision condition for decision according to the approval requester and the content of said approval request.

14. An approval system according to claim 6, wherein said acquisition means also searches the approval service stored in said approval service provider.

15. A service server comprising:
approval service storage means for storing plural approval services instructed for registration by an approval service provider; and
transmission means for searching an approval service matching the approval request and instructed for search from an external apparatus and transmitting said approval service to said external apparatus.

16. A service server according to claim 15, further comprising information means for informing said external apparatus of an information of registration when a new approval service is registered by said approval service provider.

17. An approval system comprising a service server for managing plural approval services registered by an approval service provider, a client terminal having approval request preparing means for preparing an approval request and a request server having approval request storage means for storing the approval request prepared in said client terminal;
wherein said request server includes:
approval request storage means for storing the approval request prepared in said client terminal;
acquisition means for searching and acquiring an approval service matching said approval request stored in said approval request storage means, among the plural approval services registered in said service server;
decision performing means for performing the approval decision for said approval request, utilizing said acquired approval service; and
output means for outputting the result of decision of said decision performing means.

18. An approval system according to claim 17, wherein said acquisition means retains said approval request in said approval request storage means in case the approval service matching said approval request cannot be searched in said service server, and, upon detecting registration of a new approval service in said service server, again searches and acquires the approval service matching said retained approval request.

19. An approval system according to claim 18, wherein said service server further includes information means for informing said request server of an information of registration when a new approval service is registered by said service provider.

20. An approval system according to claim 17, wherein an approval service corresponding to an approval decider is registered in said service server in response to the log-in of said approval decider in said service provider, and an approval service corresponding to said approval decider is deleted from said service server in response to the log-out of said approval decider from said service provider.

21. An approval system according to claim 17, wherein an approval service stored in a card storing the approval service is registered in said service server in response to the insertion of said card in said service provider and the approval service stored in said card is deleted from said service server in response to the extraction of said card from said service provider.

22. An approval system according to claim 21, wherein said card includes decision condition data to be used in said approval service.

23. An approval system according to claim 22, wherein said service provider prepares said approval service and registers it in said service server, based on said decision condition data of said inserted card.

24. An approval system according to claim 17, wherein said client terminal further includes reception means for receiving the decision result outputted by said output means.

25. An approval system according to claim 24, wherein said client terminal further includes execution means for executing a process corresponding to said approval request in case said received decision result is an approval.

26. An approval system according to claim 17, wherein said approval service includes a decision condition for decision according to the approval requester and the content of said approval request.

27. An approval system according to claim 17, wherein said acquisition means further searches the approval service stored in said approval service provider.

28. An approval system according to claim 17, wherein the decision result outputted by said output means is also outputted to said service provider.

29. An approval system comprising a service server for managing plural approval services registered by an approval service provider and a client terminal having approval request preparing means for preparing an approval request;
wherein said client terminal further includes:
search means for searching an approval service matching said approval request, among the plural approval services registered in said service server;
transmission means, in case said the approval service is searched by said search means, for transmitting said approval request to said service server; and
reception means for receiving the result of approval decision for said approval request transmitted from said service server; and
said service server includes:
decision performing means for performing the approval decision for the approval request transmitted from said client terminal, utilizing said acquired approval service matching said approval request; and
transmission means for transmitting the result of said approval decision to said client terminal.

30. An approval system comprising a service server for managing plural approval services registered by an approval service provider, a client terminal having approval request preparing means for preparing an approval request, and a request server having approval request storage means for storing the approval request prepared in said client terminal;
wherein said request server includes:
approval request storage means for storing the approval request prepared in said client terminal;
search means for searching an approval service matching the approval request stored in said approval request storage means, among the plural approval services registered in said service server;
transmission means adapted, in case the approval service is searched by said search means, for transmitting said approval service to said service server; and
reception means for receiving the result of approval decision for said approval request from said service server; and
said service server includes:
decision performing means for performing the approval decision for the approval request transmitted from said request server, utilizing the approval service matching said approval request; and
transmission means for transmitting the result of said approval decision to said request server.

31. An information processing method comprising:
an approval request preparing step of preparing an approval request;
a storage step of storing an approval service set by an approval service provider;
a decision step of deciding whether or not to approve said prepared approval request, utilizing said stored approval service; and
an output step of outputting the result of decision of said decision step.

32. A method according to claim 31, further comprising:
an execution step of executing a process corresponding to said approval request in case said outputted result of decision is an approval.

33. A method according to claim 31, wherein said approval service includes a decision condition for decision according to the approval requester and the content of said approval request.

34. A method according to claim 33, wherein said decision condition further includes information of an information processing method preparing said approval request.

35. A method according to claim 31, wherein said decision step discriminates a period prohibiting said decision and does not execute the approval decision for said approval request in case the current time is identified as within a prohibition period.

36. A control method for an approval system including a service server for managing plural approval services registered by an approval service provider and a client terminal having approval request preparing means for preparing an approval request, the method comprising, in said client terminal:
an approval request preparing step of preparing an approval request;
an acquisition step of searching and acquiring an approval service matching said approval request, among the plural approval services registered in said service server;
a decision performing step of performing the approval decision for said approval request, utilizing said acquired approval service; and
an output step of outputting the result of decision of said decision performing step.

37. A control method for an approval system according to claim 36, wherein said service provider registers said approval service in said service server in response to the insertion of a card storing information of said approval service and deletes the corresponding approval service from said service server in response to the extraction of said card.

38. A control method for an approval system according to claim 36, wherein the method further comprises, in said client terminal an approval request storage step of storing plural approval request in a memory; and
said decision performing step executes the approval decision process for said stored plural approval requests.

39. A control method for an approval system according to claim 38, wherein said acquisition step is adapted, upon detecting that said client terminal is connected to said service server through a network, to search and acquire an approval service matching said approval request among the plural approval services stored in said service server.

40. A control method for an approval system according to claim 39, wherein said client terminal is a portable terminal.

41. A control method for an approval system according to claim 36, wherein said acquisition step is adapted, in response to the insertion of a card storing said approval request into said client terminal, to search and acquire an approval service matching said approval request among the plural approval services stored in said service server.

42. A control method for an approval system according to claim 36, wherein the method further comprises, in said client terminal an execution step of executing a process corresponding to said approval request in case said outputted decision result is an approval.

43. A control method for an approval system according to claim 36, wherein said approval service includes a decision condition for decision according to the approval requester and the content of said approval request.

44. A control method for an approval system according to claim 36, wherein said acquisition step also searches the approval service stored in said approval service provider.

45. A control method for a service server comprising:
an approval service storage step of storing plural approval services instructed for registration by an approval service provider; and
a transmission step of searching an approval service matching the approval request and instructed for search from an external apparatus and transmitting said approval service to said external apparatus.

46. A control method for a service server according to claim 45, further comprising an information step of informing said external apparatus of an information of registration when a new approval service is registered by said approval service provider.

47. A control method for an approval system including a service server for managing plural approval services registered by an approval service provider, a client terminal for preparing an approval request and a request server having a memory for storing the approval request prepared in said client terminal;
wherein the method comprises, in said request server:
an approval request storage step of storing the approval request prepared in said client terminal;
an acquisition step of searching and acquiring an approval service matching said stored approval request, among the plural approval services registered in said service server;
a decision performing step of performing the approval decision for said approval request, utilizing said acquired approval service; and
an output step of outputting the result of decision of said decision performing step.

48. A control method for an approval system according to claim 47, wherein said acquisition step retains said approval request in said memory in case the approval service matching said approval request cannot be searched in said service server, and, upon detecting registration of a new approval service in said service server, again searches and acquires the approval service matching said retained approval request.

49. A control method for an approval system according to claim 48, wherein the method further comprises, in said service server, an information step of informing said request server of an information of registration when a new approval service is registered by said service provider.

50. A control method for an approval system according to claim 47, wherein an approval service corresponding to an approval decider is registered in said service server in response to the log-in of said approval decider in said service provider, and an approval service corresponding to said approval decider is deleted from said service server in response to the log-out of said approval decider from said service provider.

51. A control method for an approval system according to claim 47, wherein an approval service stored in a card storing the approval service is registered in said service server in response to the insertion of said card in said service provider and the approval service stored in said card is deleted from said service server in response to the extraction of said card from said service provider.

52. A control method for an approval system according to claim 51, wherein said card includes decision condition data to be used in said approval service.

53. A control method for an approval system according to claim 52, wherein said service provider prepares said approval service and registers it in said service server, based on said decision condition data of said inserted card.

54. A control method for an approval system according to claim 47, wherein the method in said client terminal further comprises a reception step for receiving the decision result outputted by said output step.

55. A control method for an approval system according to claim 54, wherein the method in said client terminal further comprises an execution step of executing a process corresponding to said approval request in case said received decision result is an approval.

56. A control method for an approval system according to claim 47, wherein said approval service includes a decision condition for decision according to the approval requester and the content of said approval request.

57. A control method for an approval system according to claim 47, wherein said acquisition step further searches the approval service stored in said approval service provider.

58. A control method for an approval system according to claim 47, wherein the decision result outputted by said output step is also outputted to said service provider.

59. A control method for an approval system including a service server for managing plural approval services registered by an approval service provider and a client terminal for preparing an approval request, the method comprising, in said client terminal:
an approval request preparing step of preparing an approval request;
a search step of searching an approval service matching said approval request, among the plural approval services registered in said service server;
a transmission step, in case said the approval service is searched by said search step, for transmitting said approval request to said service server; and
a reception step of receiving the result of approval decision for said approval request transmitted from said service server; and
the method comprising in said service server:
a decision performing step of performing the approval decision for the approval request transmitted from said client terminal, utilizing said approval service matching said approval request; and
a transmission step of transmitting the result of said approval decision to said client terminal.

60. A control method for an approval system including a service server for managing plural approval services registered by an approval service provider, a client terminal for preparing an approval request, and a request server having a memory for storing the approval request prepared in said client terminal;
wherein the method in said request server comprises:
an approval request storage step of storing the approval request prepared in said client terminal;
a search step of searching an approval service matching the approval request stored in said approval request storage step, among the plural approval services registered in said service server;
a transmission step adapted, in case the approval service is searched by said search step, for transmitting said approval service to said service server; and
a reception step of receiving the result of approval decision for said approval request from said service server; and
the method in said service server comprising:
a decision performing step of performing the approval decision for the approval request transmitted from said request server, utilizing the approval service matching said approval request; and
a transmission step of transmitting the result of said approval decision to said request server.

61. A computer program composed of computer executable codes comprising:
an approval request preparing step of preparing an approval request;
a storage step of storing an approval service set by an approval service provider;
a decision step of deciding whether or not to approve said prepared approval request, utilizing said stored approval service; and
an output step of outputting the result of decision of said decision step.

62. A computer executable control program for controlling an approval system including a service server for managing plural approval services registered by an approval service provider and a client terminal having approval request preparing means for preparing an approval request, the method comprising, in said client terminal:
an approval request preparing step of preparing an approval request;
an acquisition step of searching and acquiring an approval service matching said approval request, among the plural approval services registered in said service server;
a decision performing step of performing the approval decision for said approval request, utilizing said acquired approval service; and
an output step of outputting the result of decision of said decision performing step.

63. A computer executable control program for a service server comprising:
an approval service storage step of storing plural approval services instructed for registration by an approval service provider; and
a transmission step of searching an approval service matching the approval request and instructed for search from an external apparatus and transmitting said approval service to said external apparatus.

64. A computer executable control program for an approval system including a service server for managing plural approval services registered by an approval service provider, a client terminal for preparing an approval request and a request server having a memory for storing the approval request prepared in said client terminal;
wherein the program comprises, in said request server:
an approval request storage step of storing the approval request prepared in said client terminal;
an acquisition step of searching and acquiring an approval service matching said stored approval request, among the plural approval services registered in said service server;
a decision performing step of performing the approval decision for said approval request, utilizing said acquired approval service; and
an output step of outputting the result of decision of said decision performing step.

65. A computer executable control program for an approval system including a service server for managing plural approval services registered by an approval service provider and a client terminal for preparing an approval request, the program comprising, in said client terminal:
an approval request preparing step of preparing an approval request;
a search step of searching an approval service matching said approval request, among the plural approval services registered in said service server;
a transmission step, in case said the approval service is searched by said search step, for transmitting said approval request to said service server; and
a reception step of receiving the result of approval decision for said approval request transmitted from said service server; and
the program comprising in said service server:
a decision performing step of performing the approval decision for the approval request transmitted from said client terminal, utilizing said approval service matching said approval request; and
a transmission step of transmitting the result of said approval decision to said client terminal.

66. A computer executable control program for an approval system including a service server for managing plural approval services registered by an approval service provider, a client terminal for preparing an approval request, and a request server having a memory for storing the approval request prepared in said client terminal;
wherein the program in said request server comprises:
an approval request storage step of storing the approval request prepared in said client terminal;
a search step of searching an approval service matching the approval request stored in said approval request storage step, among the plural approval services registered in said service server;
a transmission step adapted, in case the approval service is searched by said search step, for transmitting said approval service to said service server; and
a reception step of receiving the result of approval decision for said approval request from said service server; and
the program in said service server comprising:
a decision performing step of performing the approval decision for the approval request transmitted from said request server, utilizing the approval service matching said approval request; and
a transmission step of transmitting the result of said approval decision to said request server.
